(19) United States
(12) Patent Application Publication
(10) Pub. No.: US 2018/0136017 A1
(43) Pub. Date: May 17, 2018

(54) INTEGRATION OF FIBER OPTIC SENSORS INTO SLEEVE

(71) Applicant: Lloyd's Register Americas, Inc., Houston, TX (US)

(72) Inventor: Alan Turner, Houston, TX (US)

(21) Appl. No.: 15/704,229

(22) Filed: Sep. 14, 2017

Related U.S. Application Data
(60) Provisional application No. 62/394,847, filed on Sep. 15, 2016.

(51) Int. Cl. G01D 5/353

(52) U.S. Cl. CPC G01D 5/35374; G01D 5/35316

(57) ABSTRACT

Systems and methods are provided for monitoring industrial equipment in operational state or subsequent to repair. In addition, systems and methods are provided for detection and diagnostics of equipment failure in order to inform of a cause of the failure and the timing of the failure. Moreover, systems and methods are provided for simultaneous repair and monitoring of the results of the repair by integrating sensors into the repaired area while performing the repair. A system for monitoring physical properties of industrial equipment includes a portion of industrial equipment, a fiber-optic sensor that measures the physical properties of the portion of industrial equipment, a sleeve placed over an external surface of the portion of industrial equipment, and an attachment layer placed between the sleeve and the portion of industrial equipment that attaches the sleeve to the portion of industrial equipment.

In various aspects, the invention is related to a Fiber Bragg Grating (FBG) application in systems for maintaining performance of industrial equipment during and subsequent to repair. Specifically, the invention is related to using FBG sensors for monitoring physical integrity of systems for transporting or containing fluids while maintaining desired properties of the fluids.

This application claims priority to Provisional application No. 62/394,847, filed on Sep. 15, 2016.

### BACKGROUND OF THE INVENTION

FBG application in industrial equipment maintenance and diagnostics is an area of increasing interest in various industries, such as the oil and gas industry, the building and construction industry, airplane manufacturing, and ship manufacturing, to name a few.

Recently, FBGs have been used extensively in the telecommunication industry for dense wavelength division de-multiplexing, dispersion compensation, laser stabilization, and erbium amplifier gain flattening, all at 1550 nanometer (nm). In addition, FBGs have been utilized for a wide variety of mechanical sensing applications including monitoring of civil structures (highways, bridges, buildings, dams, etc.), smart manufacturing and non-destructive testing (composites, laminates, etc.), remote sensing (oil wells, power cables, pipelines, space stations, etc.), smart structures (airplane wings, ship hulls, buildings, sports equipment, etc.), electrical equipment (transformers, motors, generators, etc.) as well as traditional strain, pressure and temperature sensing. One of the main advantages of FBGs for mechanical sensing is that these devices perform a direct transformation of the sensed parameter to an optical wavelength, independent of light levels, connector or fiber losses, or other FBGs at different wavelengths.

The advantages of FBGs over, for example, resistive foil strain gages are numerous. FBGs are entirely passive, and hence, they do not produce resistive heating. In comparison with the strain gages, FBGs are small in size and, as a result, can be successfully embedded and laminated. Due to the fact that FBGs are narrowband with a wide wavelength operating range, they can be highly multiplexed. FBGs are non-conductive, and this property renders them immune to electromagnetic interference. Moreover, foil strain gages are less environmentally stable than FBGs, considering that the strain gages are normally made of copper, and not glass. FBG sensors can be located many miles from a source, because a low fiber loss at 1550 nm wavelength. Further, FBGs are a low-cost solution over the foil strain gages, due to device simplicity and high volume telecommunication usage. As many as 40 sensors on one channel allow for small cable harnesses and minimal feed through along with a small electronic foot print for the signal conditioning unit.

Some of the identified advantages of the FBG technology have been conventionally implemented, for example, in the oil and gas distribution and transportation industry, specifically with respect to equipment diagnostics and failure detection. Traditionally, FBGs have been applied on pipelines run through complex geological areas to monitor external forces acting on the pipelines due to, for example, tectonic changes in the geological environment. Nonetheless, the desirable features of the FBGs have been traditionally underutilized in regard to equipment repair and monitoring of the health of the repair. This area of industrial equipment maintenance and quality control is in need of improved reliability and sophistication, which can be achieved by the versatile FBG technology.

### SUMMARY OF THE INVENTION

Systems and methods are provided for monitoring industrial equipment in operational state or subsequent to repair. In addition, systems and methods are provided for detection and diagnostics of equipment failure in order to inform of a cause of the failure and the timing of the failure. Moreover, systems and methods are provided for simultaneous repair and monitoring of the results of the repair by integrating sensors into the repaired area while performing the repair.

In one embodiment, a system for monitoring physical properties of industrial equipment comprises a portion of industrial equipment, at least one fiber-optic sensor that measures the physical properties of the portion of industrial equipment, a sleeve placed over an external surface of the portion of industrial equipment, and an attachment layer placed between the sleeve and the portion of industrial equipment that attaches the sleeve to the portion of industrial equipment. The at least one fiber-optic sensor is inserted either in between the external surface of the portion of industrial equipment and an external surface of the sleeve, or on the external surface of the sleeve, or sensor sets may be inserted in both of these places.

In the system for monitoring physical properties of industrial equipment, the at least one fiber-optic sensor may be a Fiber Bragg Grating sensor. Further, the portion of industrial equipment may be a pipe and the sleeve may be a patch placed on the pipe for repair. The at least one fiber-optic sensor may provide diagnostics of a patched portion of the pipe subsequent to the repair. In addition, the attachment layer may be an adhesive material between the portion of industrial equipment and the sleeve and the at least one fiber-optic sensor may be submerged in the adhesive material. On the other hand, the at least one fiber-optic sensor may be integrated with the sleeve. Further, the at least one fiber-optic sensor may comprise an axial sensor that is substantially aligned with an axial axis of the monitored industrial equipment, and a hoop sensor that is substantially perpendicular to the axial axis of the monitored industrial equipment. Moreover, the at least one fiber-optic sensor may further comprise at least one set of sensors placed between the external surface of the portion of industrial equipment and the external surface of the sleeve, and at least one set of sensors placed on the external surface of the sleeve.

In another embodiment, a method for monitoring physical properties of industrial equipment comprises preparing a portion of industrial equipment for sensor monitoring, placing a sleeve and at least one fiber-optic sensor over the external surface of the portion of industrial equipment, using an attachment layer to attach the sleeve to the portion of industrial equipment, and measuring the physical properties of the portion of industrial equipment with the at least one fiber-optic sensor. The at least one fiber-optic sensor may be inserted in between the external surface of the portion of industrial equipment and an external surface of the sleeve, or on the external surface of the sleeve, or sensor sets may be inserted in both of these places.

The at least one fiber-optic sensor may be a Fiber Bragg Grating sensor, the portion of industrial equipment may be a pipe, and the sleeve may be a patch placed on the pipe for repair. The method for monitoring physical properties of industrial equipment may further include using the at least one fiber-optic sensor to provide diagnostics of a patched portion of the pipe subsequent to the repair. The attachment layer may be an adhesive material between the portion of industrial equipment and the sleeve.

The method for monitoring physical properties of industrial equipment may also include submerging the at least one fiber-optic sensor in the adhesive material or integrating the at least one fiber-optic sensor with the sleeve. In the method, the at least one fiber-optic sensor may comprise an axial sensor that is substantially aligned with an axial axis of the monitored industrial equipment, and a hoop sensor that is substantially perpendicular to the axial axis of the monitored industrial equipment. The at least one fiber-optic sensor may further comprise at least one set of sensors placed between the external surface of the portion of industrial equipment and the external surface of the sleeve, and at least one set of sensors placed on the external surface of the sleeve.

### BRIEF DESCRIPTION OF THE FIGURES

FIGS. 1(A) and 1(B) show a schematic of a single mode optical fiber.

FIGS. 2(A)-2(D) schematically show transmission and reflection spectra of an FBG.

FIGS. 3(A)-3(C) schematically show grating sensors at different fiber locations with separate central wavelengths and spectral operating window bands allocated.

FIG. 4 pictorially shows a pipe prepped for sensor installation.

FIG. 5 schematically shows sensors mounted in the hoop (pressure) direction and in the axial (bending) direction.

FIGS. 6(A) and 6(B) pictorially show a set of FBGs in a metal carrier and a set of bare FBGs mounted on a prepped pipe.

FIGS. 7(A) and 7(B) pictorially show epoxy application over the sensors and sensor leads for protection during clamp installation.

FIG. 8 pictorially shows sensor and lead damage subsequent to mechanical processing.

FIG. 9 pictorially shows a set of sensors installed on a clamp (repair sleeve).

FIG. 10 pictorially shows metal bonding adhesive applied to the inside surfaces of a clamp half.

FIG. 11 pictorially shows the clamps with chains wrapped around the pipe and torqued.

FIG. 12 pictorially shows E-Glass wrap applied over the sensors and the clamp.

FIG. 13 pictorially shows the equipment set up for monitoring and recording the sensor response in the repair sleeve applied on the pipe.

FIG. 14 shows a graph that reflects sensor failure (and survival) mounted on the pipe surface under the clamp.

FIG. 15 shows a graph that reflects sensor failure (and survival) mounted on the clamp surface.

FIG. 16 shows a graph that reflects response of the sensors mounted on the clamp surface during torqueing.

FIG. 17 shows a graph that reflects response of the clamp sensors during curing of the E-glass resin.

FIGS. 18(A) and 18(B) show graphs that reflect externally induced responses of the clamp sensors at a steady state.

FIG. 19 shows a graph that reflects response of the clamp sensors at an uninterrupted steady state.

FIG. 20 schematically shows an example layout of the sensors in a flat plane.

FIG. 21 schematically shows an example repair in its final configuration.

### DETAILED DESCRIPTION OF THE EMBODIMENTS

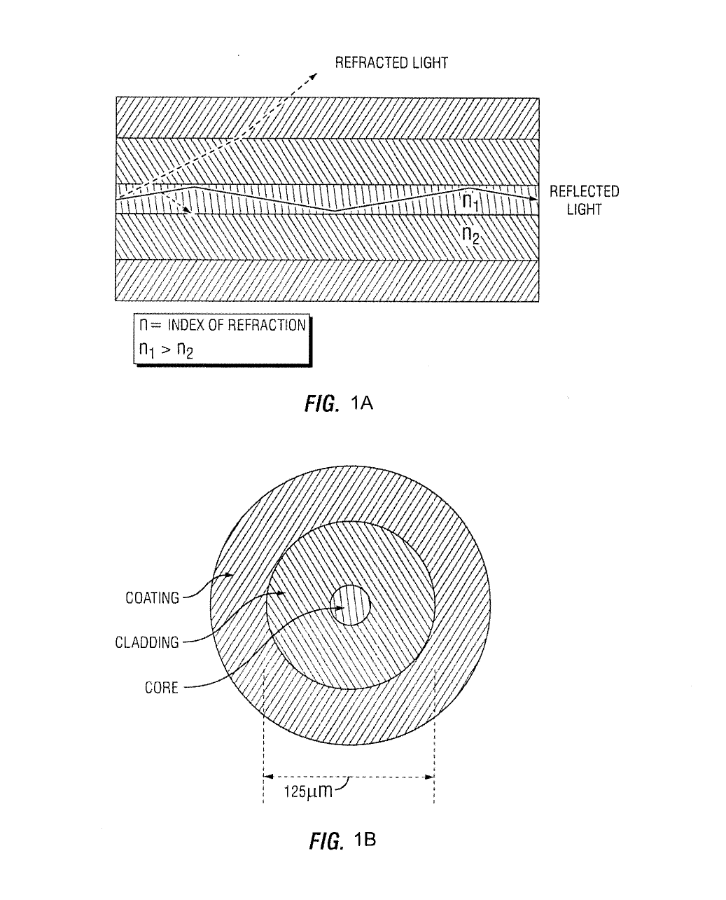

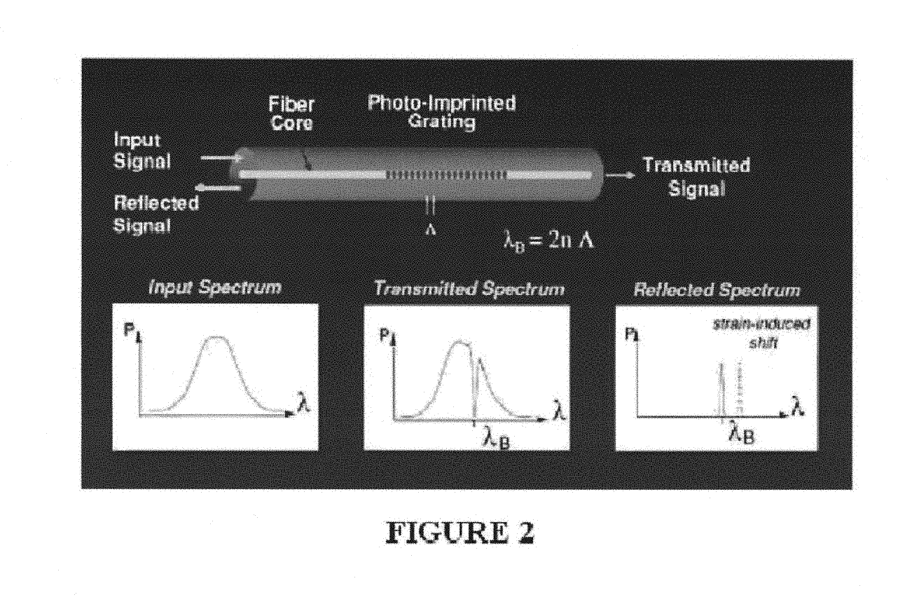

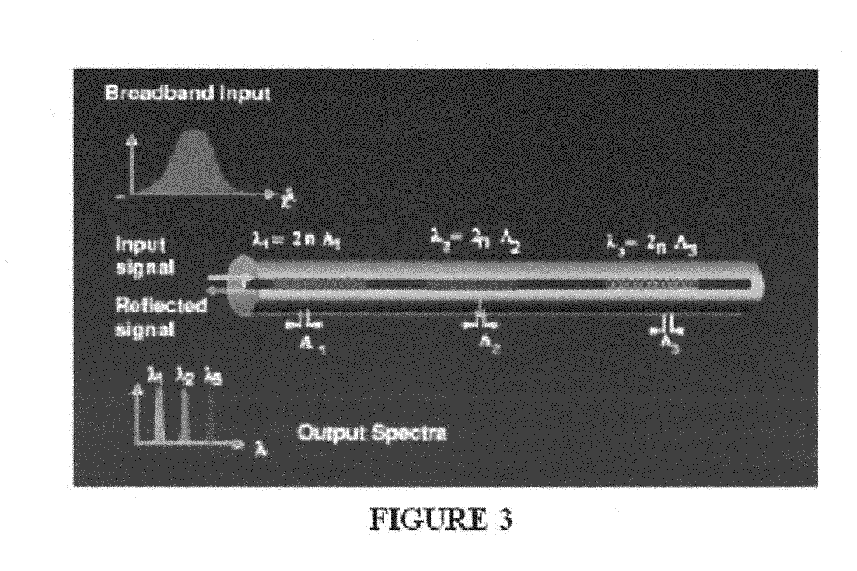

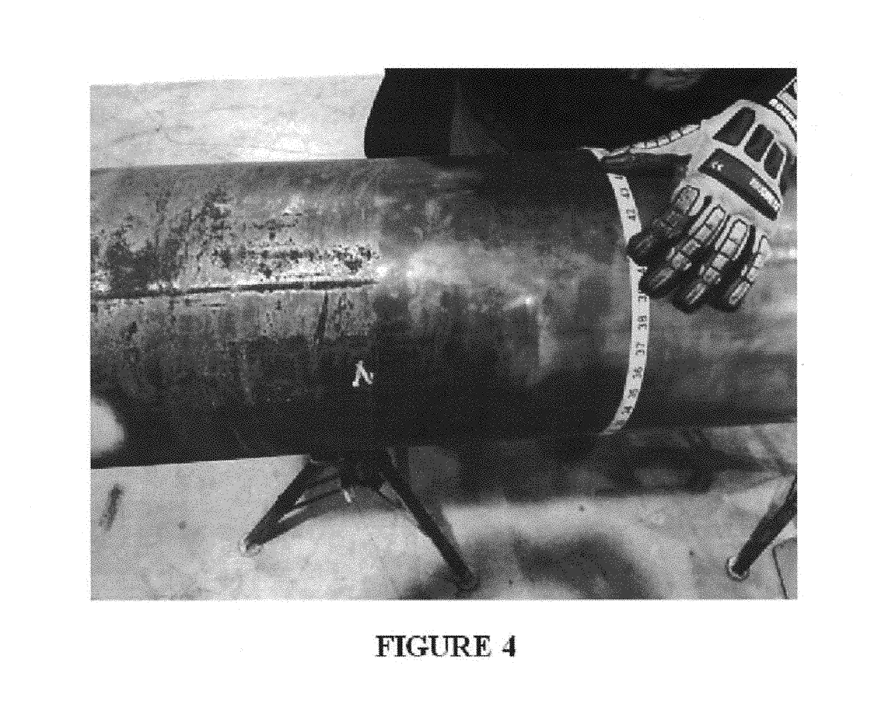

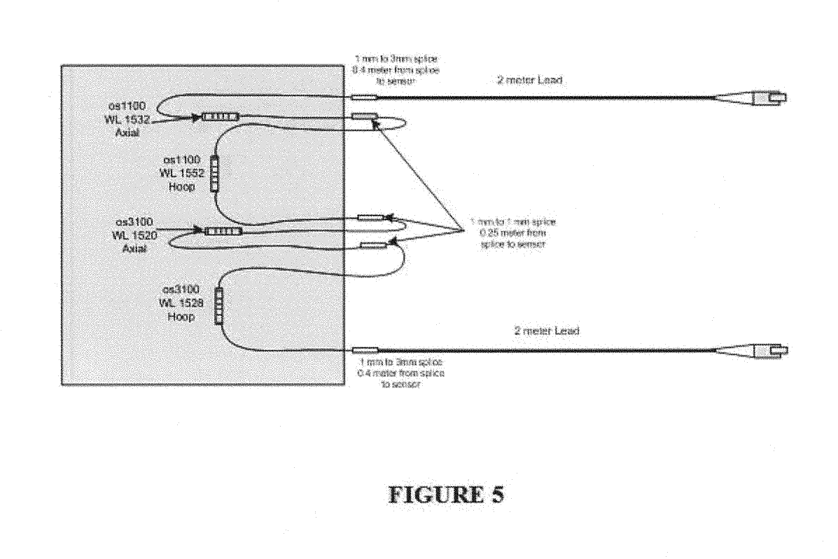

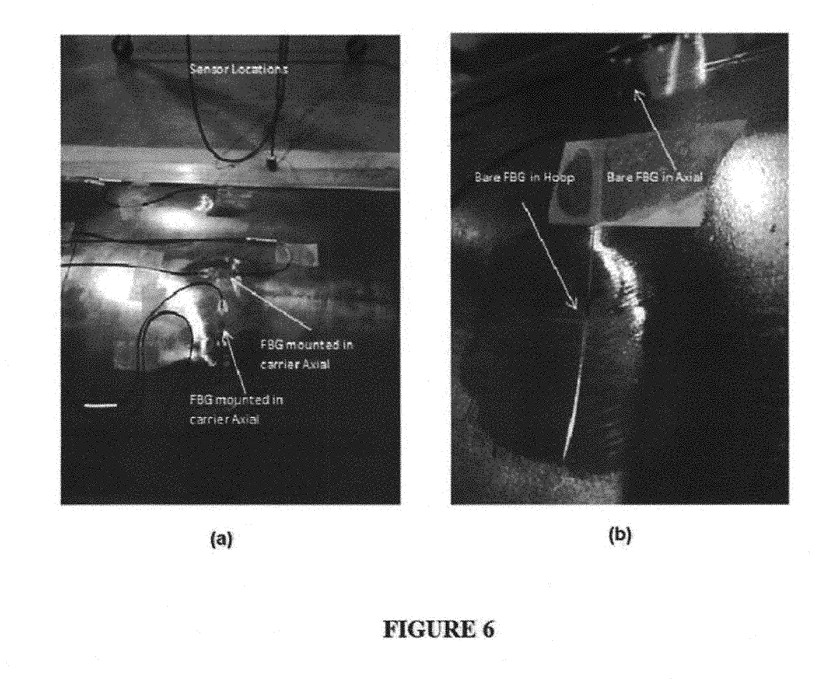

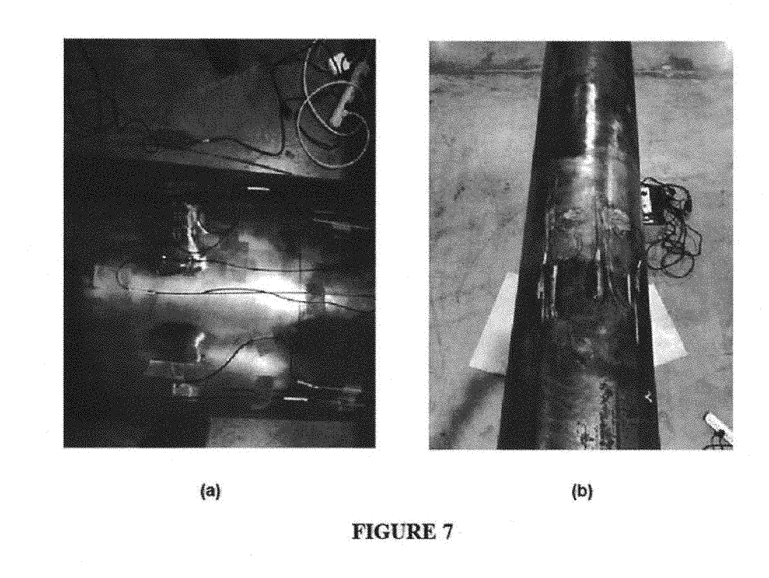

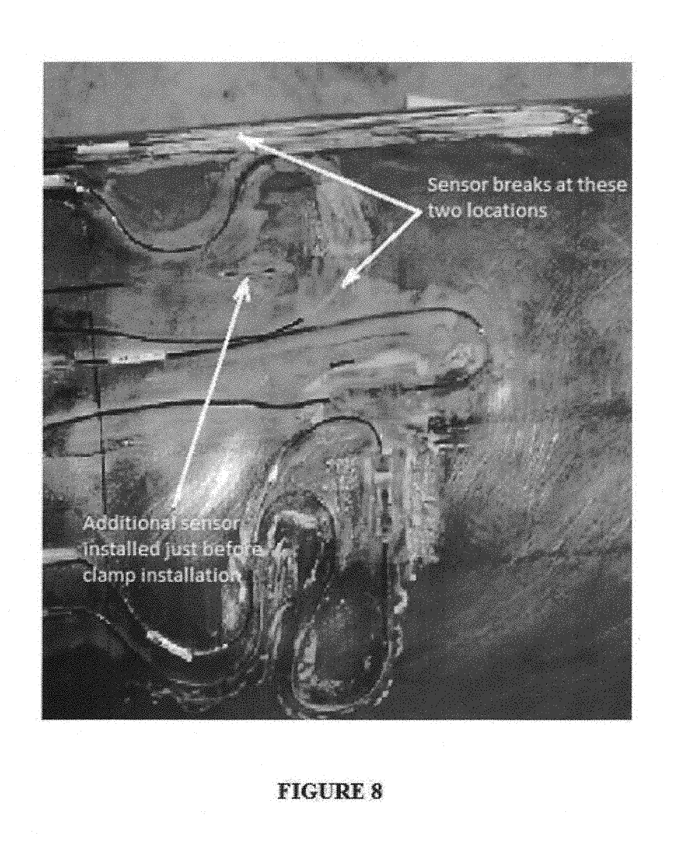

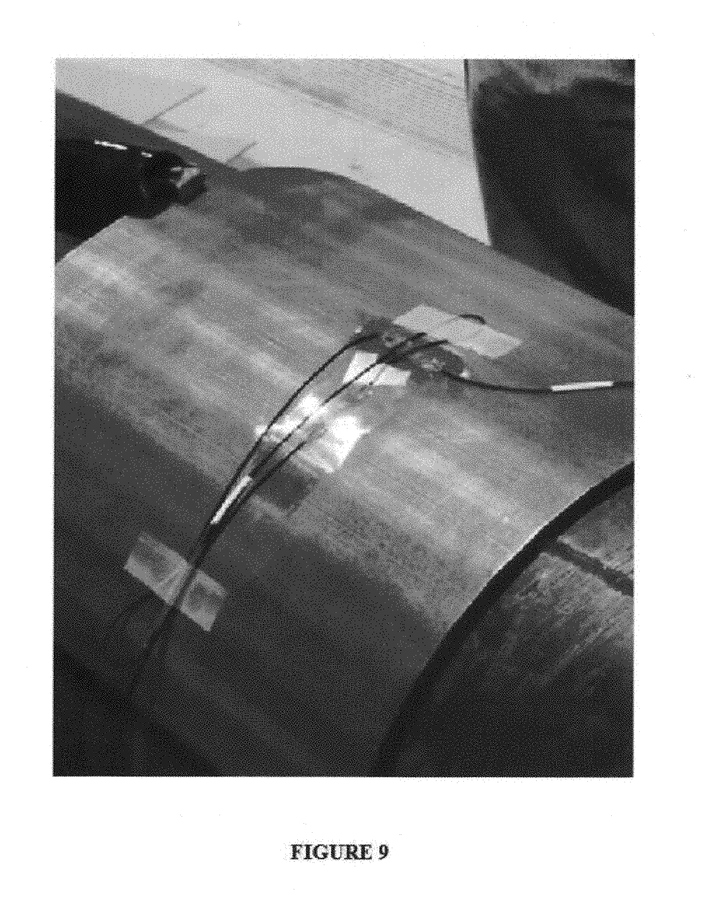

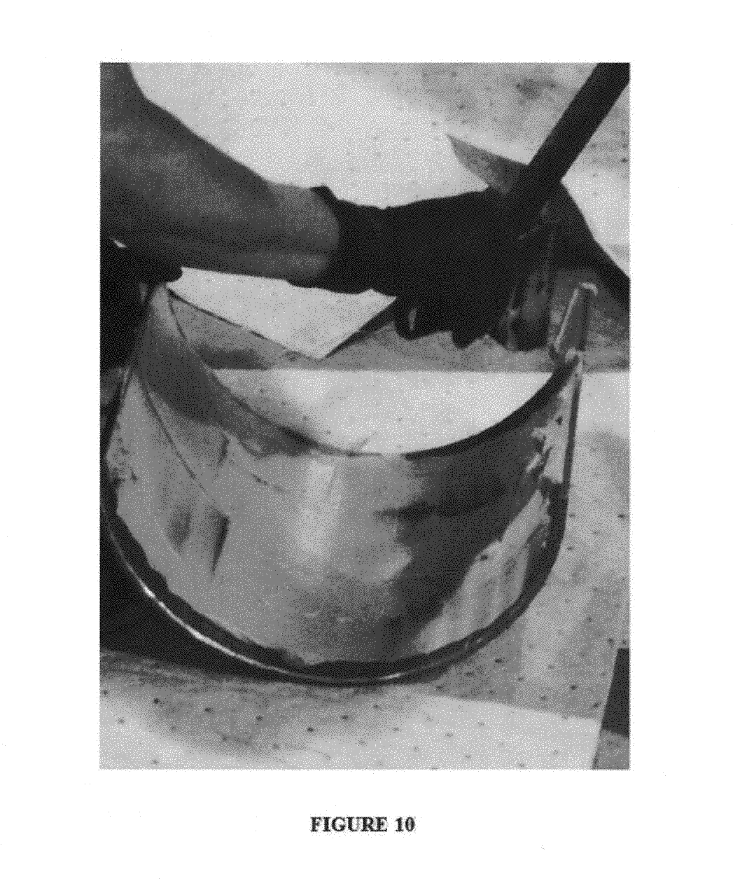

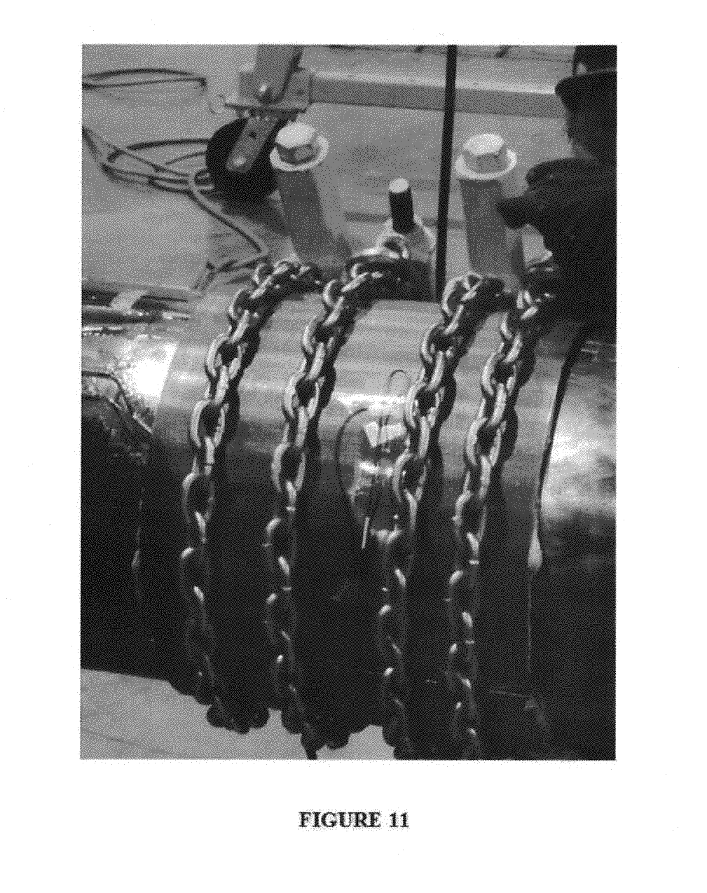

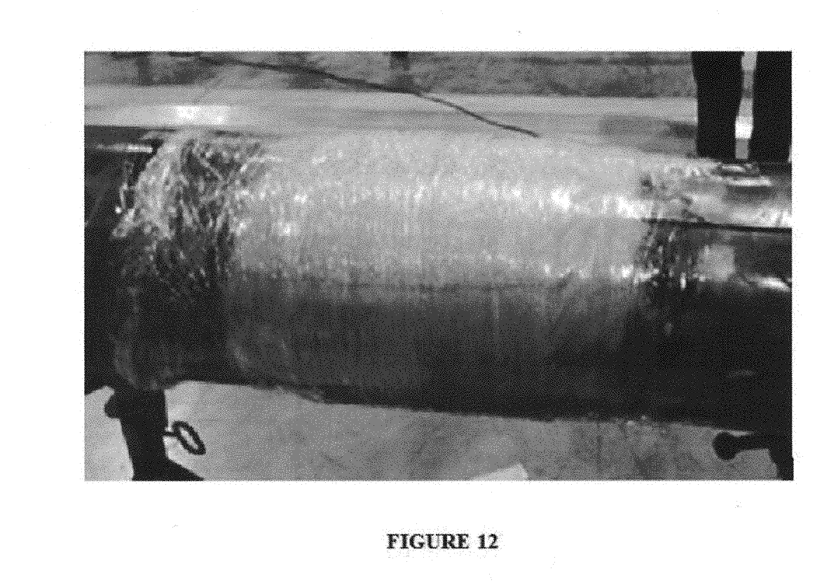

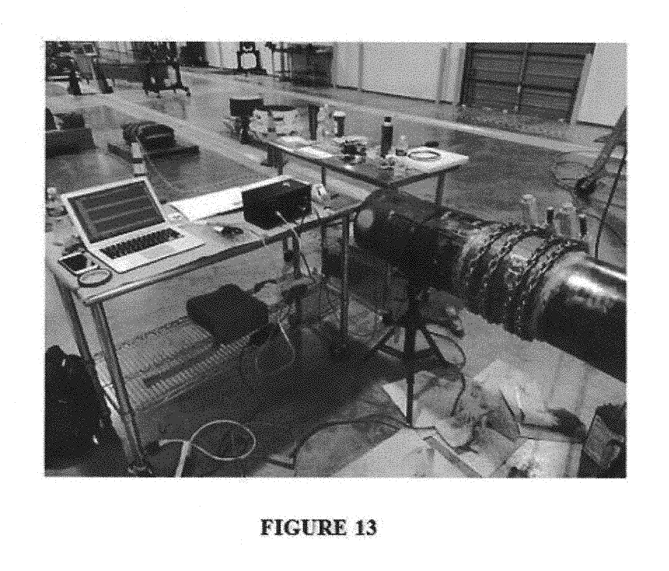

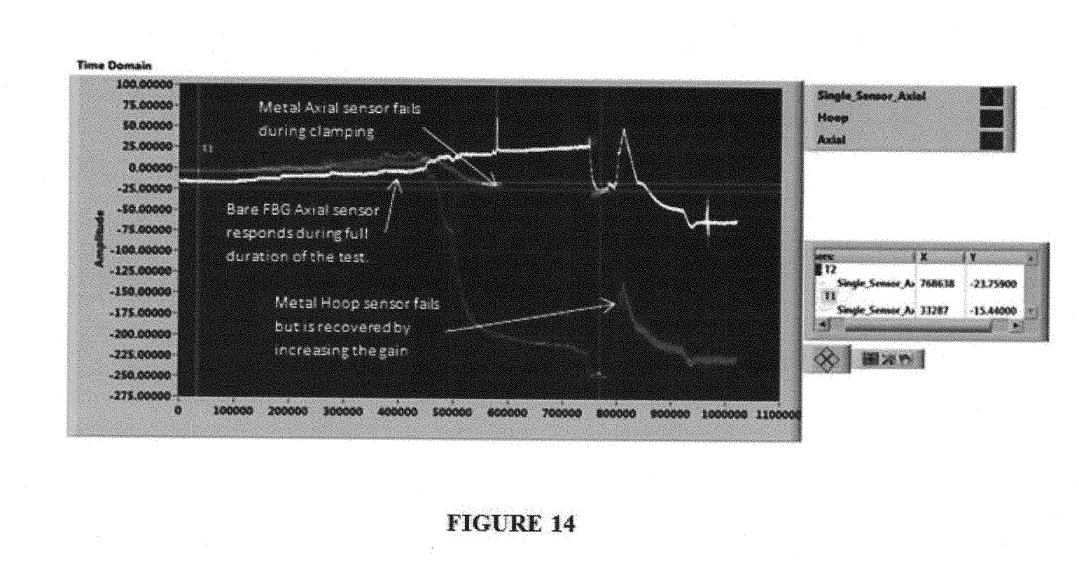

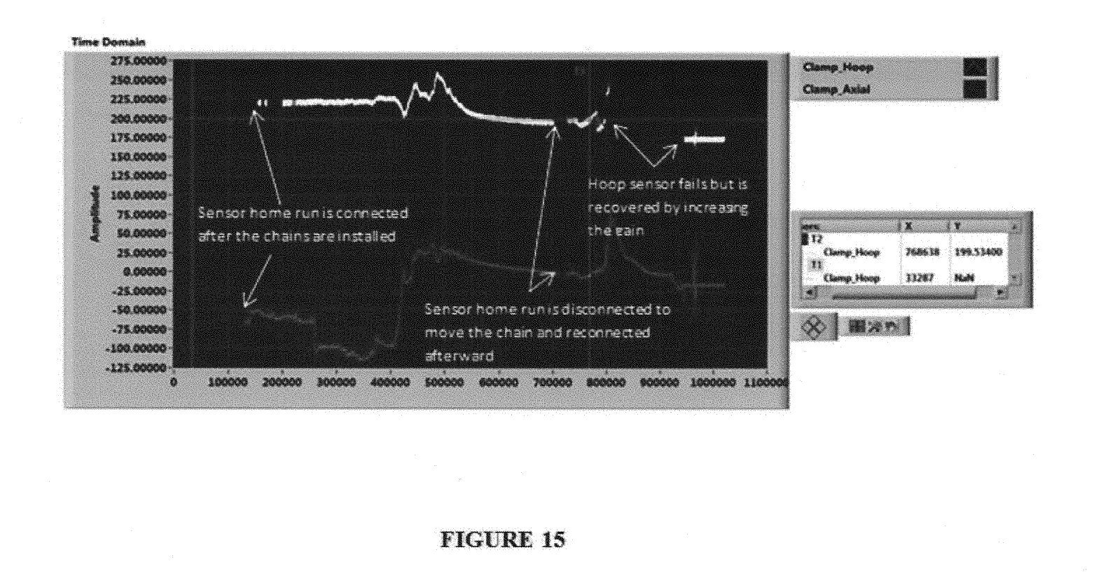

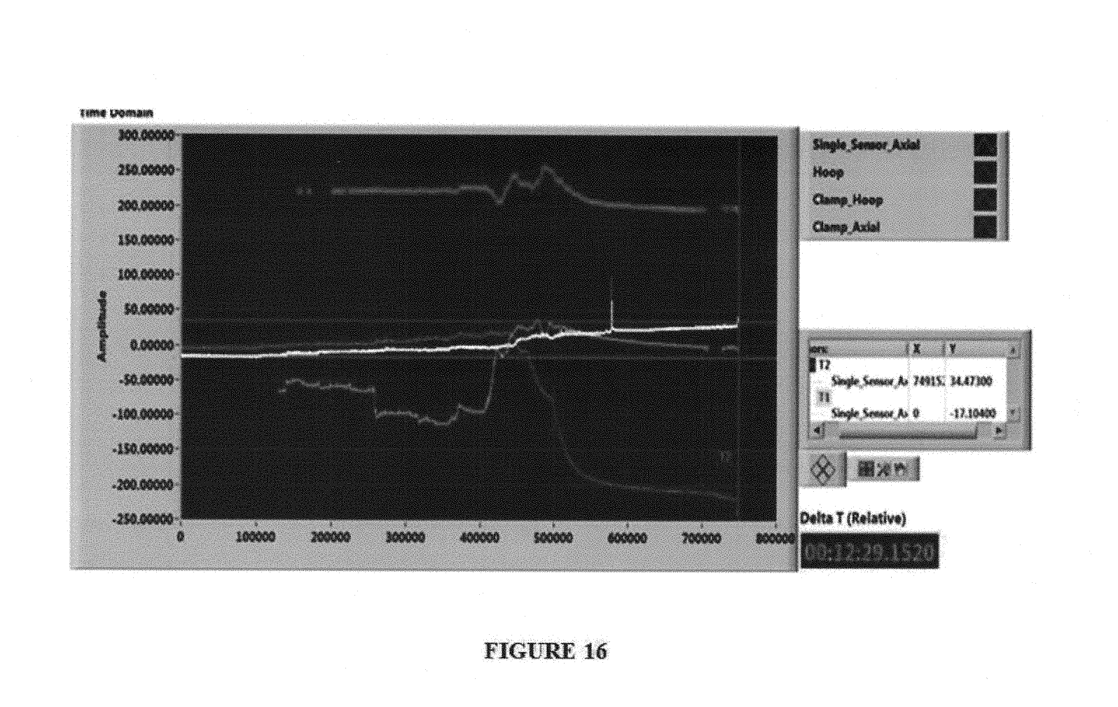

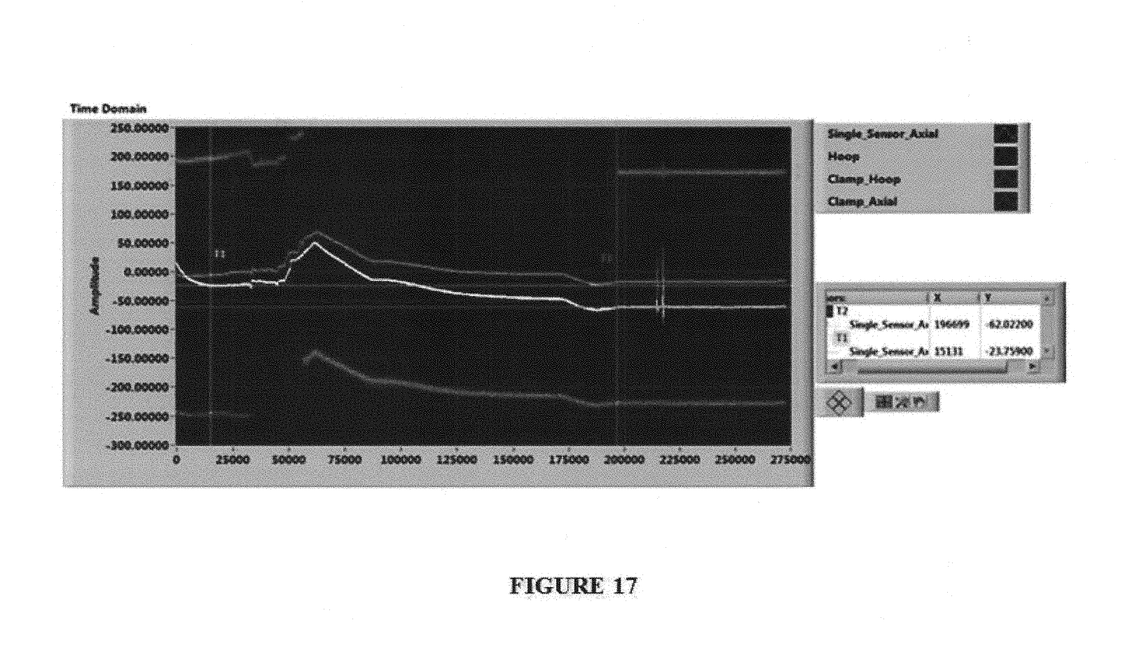

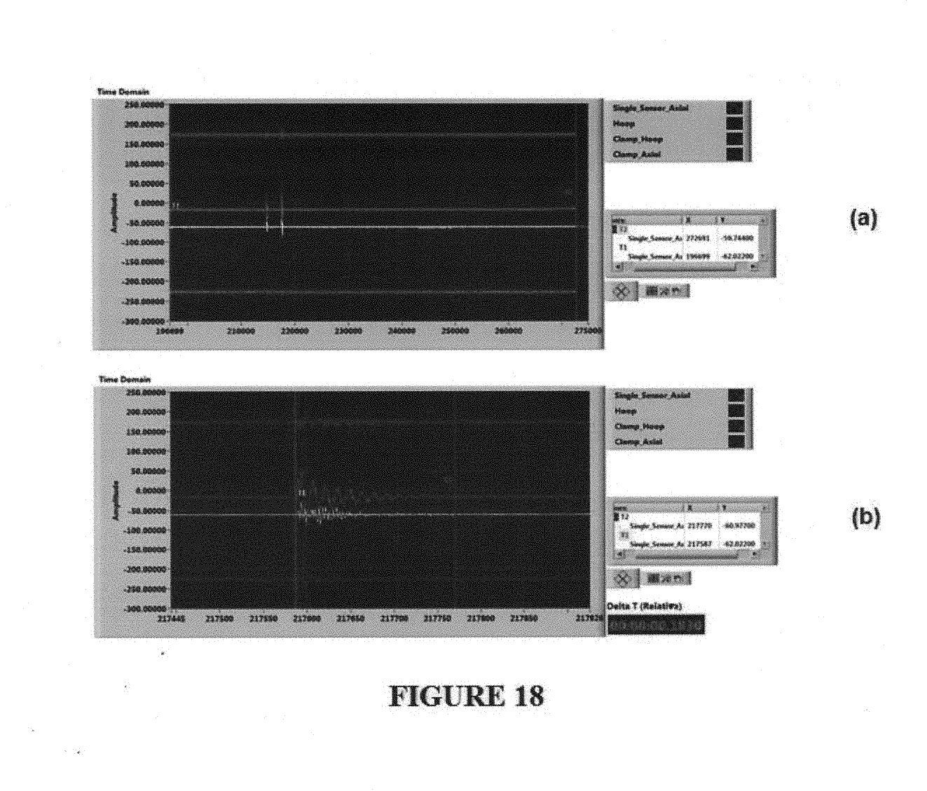

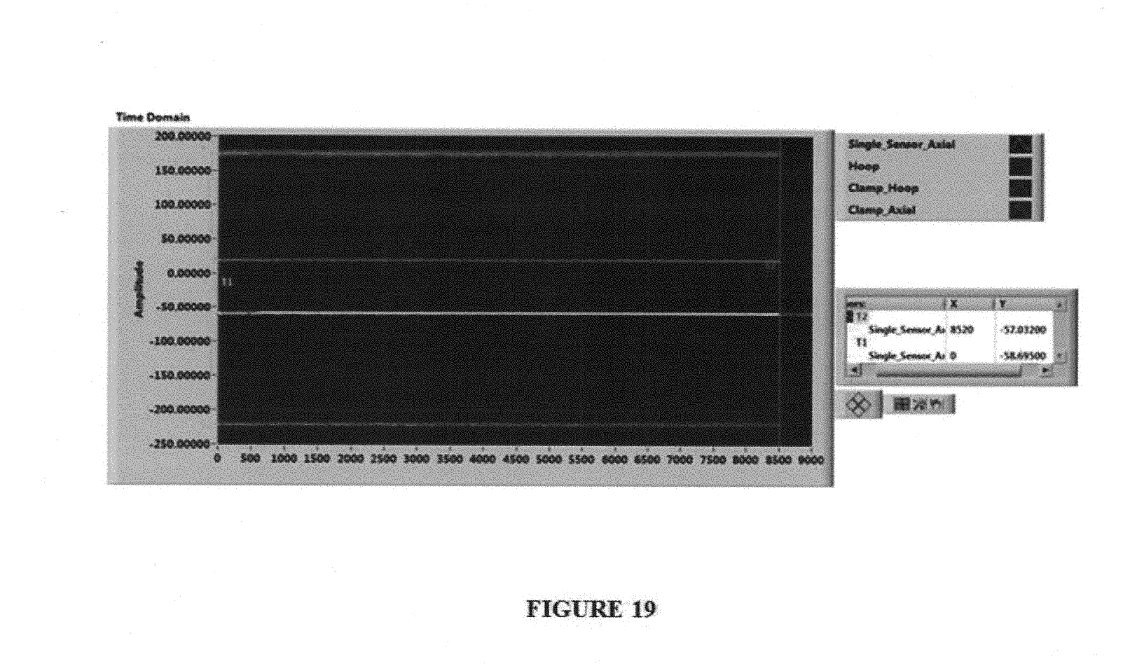

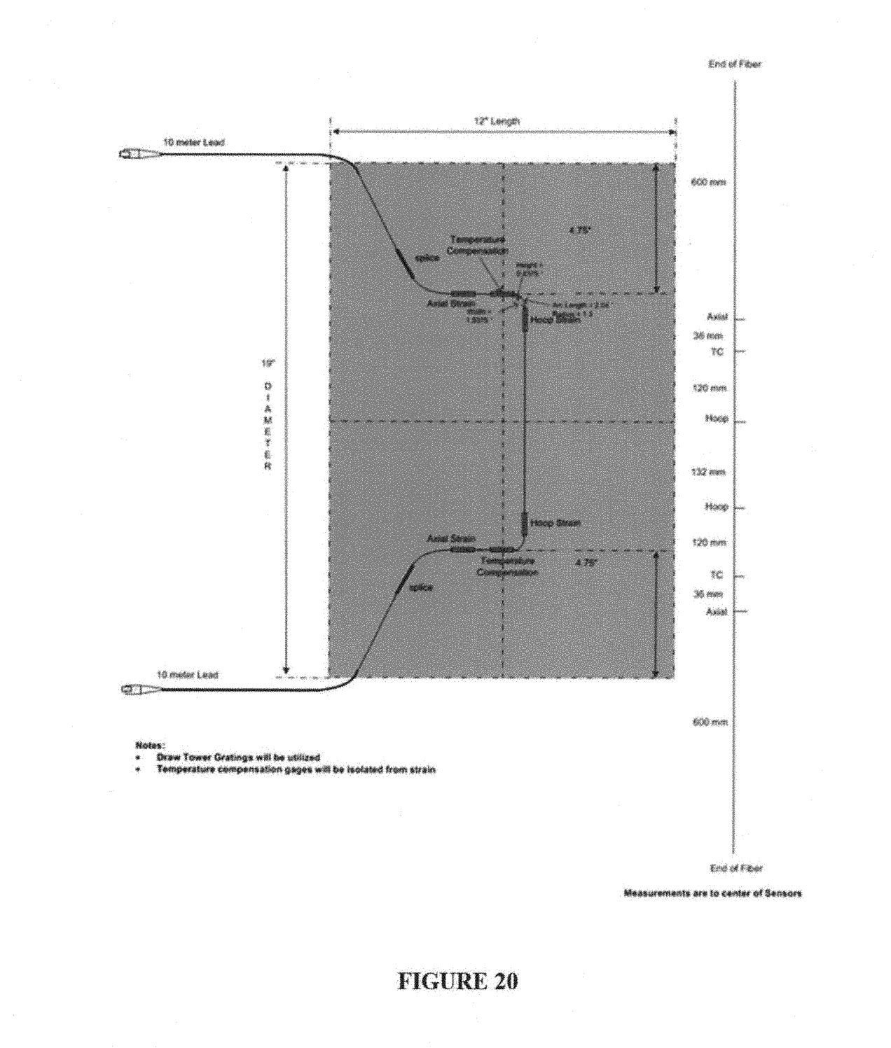

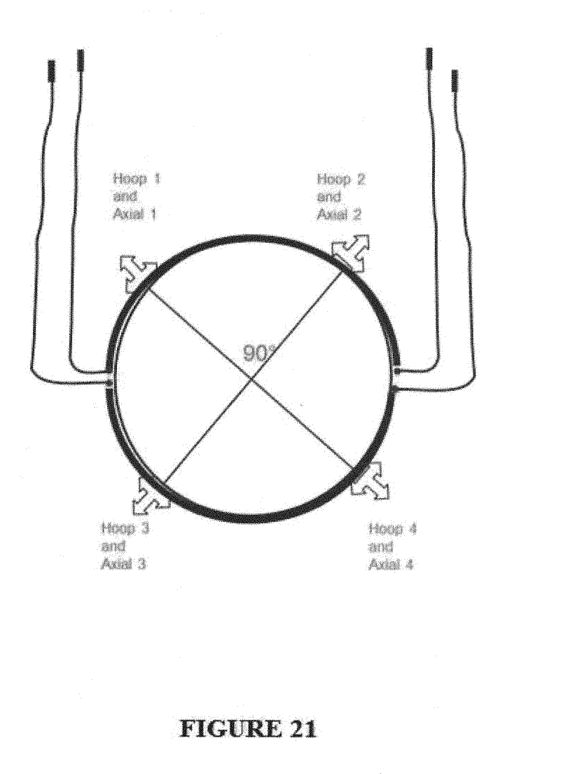

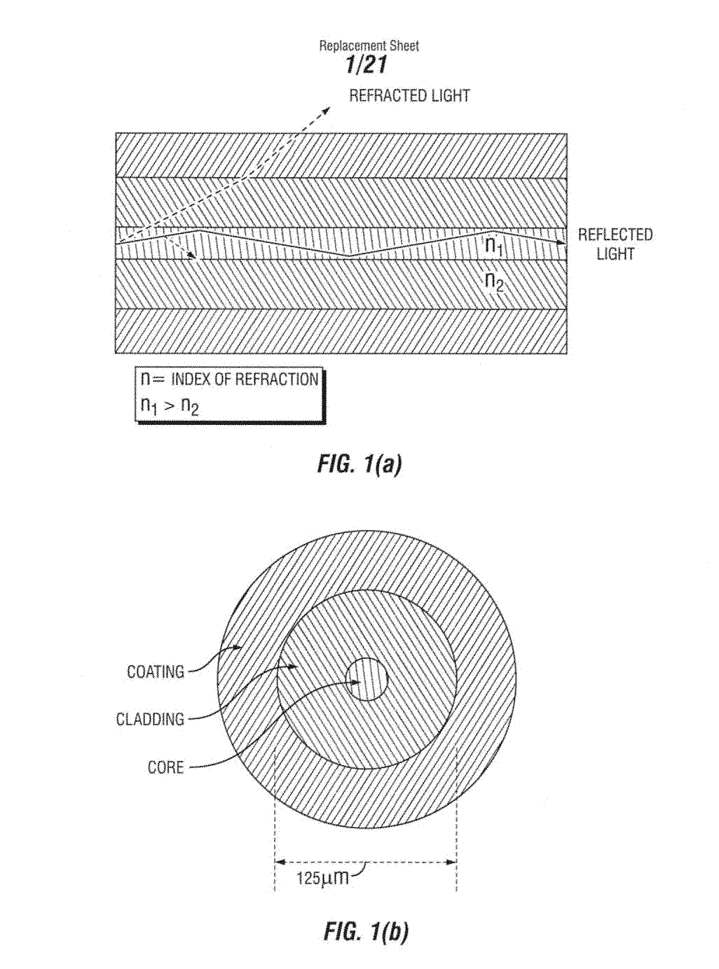

In various aspects, systems and methods are provided for using optical fiber for diagnostics and performance monitoring of a repaired piece of equipment. The optical fiber is a hair-thin cylindrical filament made of glass, which is able to guide light through itself by confining it within regions having different optical indices of refraction. A typical fiber structure is depicted in FIGS. 1(A) and 1(B). The central portion of the fiber, where most of the light travels, is called the core. Surrounding the core there is a region having a lower index of refraction, called the cladding. Stated in a simplified manner, light trapped inside the core travels along the fiber by bouncing off the interfaces with the cladding, due to the effect of the total internal reflection occurring at these boundaries. The optical energy propagates along the fiber in the form of waveguide modes that satisfy Maxwell's equations as well as the boundary conditions and the external perturbations present at the fiber.

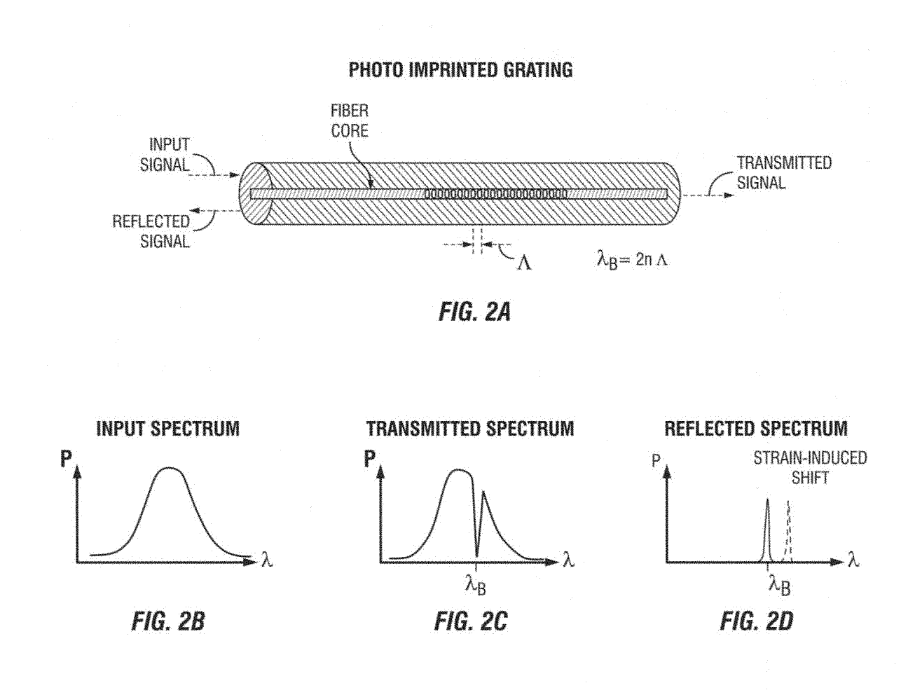

A Fiber Bragg Grating (FBG) is a wavelength-dependent filter/reflector formed by introducing a periodic refractive index structure, with spacing on the order of a wavelength of light, within the core of an optical fiber. Whenever a broad-spectrum light beam impinges on the grating, a portion of its energy is transmitted through while another portion is reflected off as depicted in FIGS. 2A-2D.

The reflected light signal will be relatively narrow (a few nm) and will be centered at the Bragg wavelength (λ_{b}) which corresponds to twice the periodic unit spacing Λ. This is the so-called Bragg condition and is expressed as:

λ_{b}=2Λnₘ Equation 1

, where Λ is the grating's period and nₘ is the average index of refraction seen by the propagating light wave inside the fiber's core. Any change in the modal index or grating pitch of the fiber caused by strain, temperature or polarization changes will result in a Bragg wavelength shift. In general, the temperature sensitivity of a grating occurs principally as a result of the temperature dependence of the refractive index in the fiber material and, to a lesser extent, the thermal expansion in the material which changes the grating period spacing. Typically, the fractional wavelength change in the peak Bragg wavelength, for temperature, is of the order of 10 pm/° C. at 1550 nm. The basic relationship between wavelength and strain for an FBG based gage is:

$$ɛ = \frac{Δ WL / {WL}_{o}}{{F}_{G}} \qquad Equation 2$$

where:

ε=Strain (m/m)
ΔWL=Wavelength shift (nm)

### WL₀=Initial Reference Wavelength (nm)

F_{G}=Gage factor (dimensionless).

It is notable that for accurate strain measurements the temperature effects must be subtracted from the strain measurement. This is known as temperature compensation and is achieved by locating a temperature compensation gage in close proximity to the strain gage.

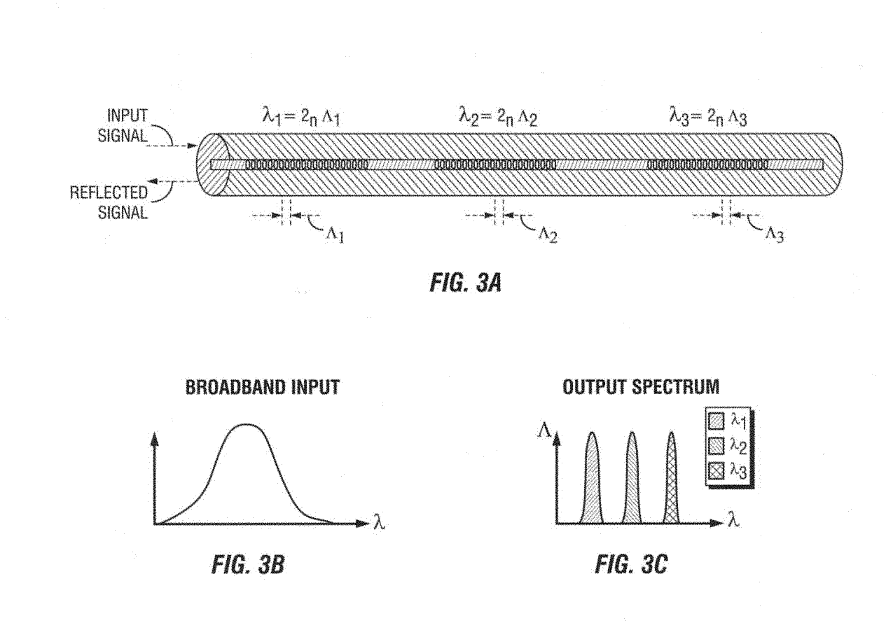

FIGS. 3A-3C illustrates an example of multiple FBGs being included along a single fiber, which permits for many sensors on one fiber optic sensor array. This allows for monitoring multiple parameters at multiple locations, such as temperature and strain, along one fiber. In general, monitoring parameters can be divided into five categories: overburden parameters, re-rate parameters, corrosion and crack monitoring parameters, calibration set-up parameters, and repair area movement parameters.

A sensor interrogator measures the FBG sensors' response, specifically detecting FBG wavelength shifts with high resolution, accuracy, and speed. These versatile instruments can interrogate hundreds of sensors at kHz speeds simultaneously, with two picometer (2 pm) wavelength stability and sub-picometric resolution and repeatability.

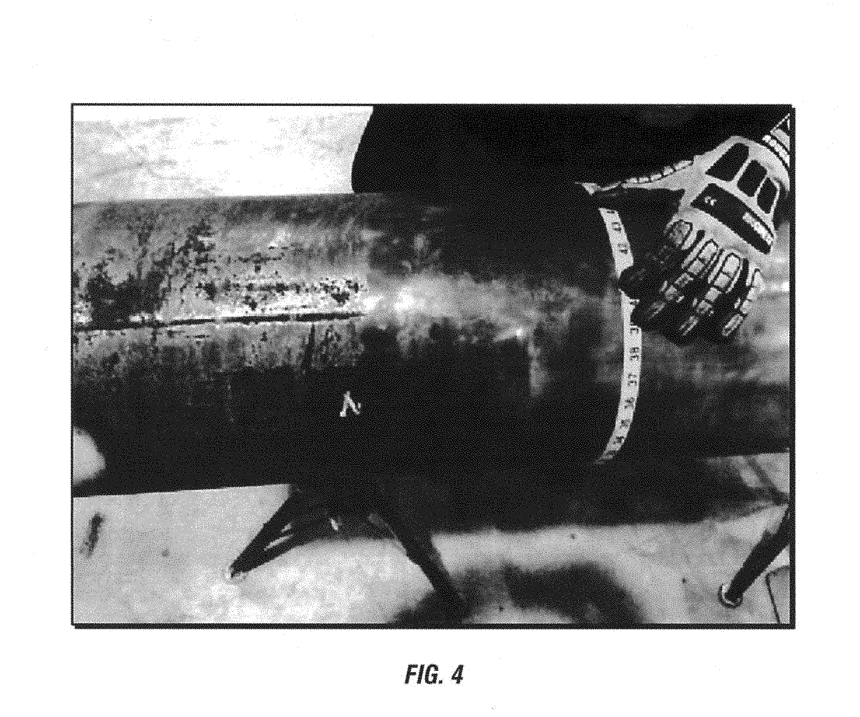

In one embodiment of the present invention, measurements of mechanical properties are performed on a pipe shown in FIG. 4. For the purpose of the test, a 12″ diameter, 5′ long by ⅜″ wall thickness pipe and stands is prepped for FBG sensor installation with an electric grinder and a wire brush. The dimensions of the pipe used for the test are not limiting but merely exemplary. While the tested pipe or any other object of interest may be intact and operational, the tested equipment may previously exhibit fluid leakage, or may include significant corrosion wear or any other type of damage or failure. In other words, FBG sensors may be integrated in a repair patch during the damage or failure repair and, subsequent to the repair, directly provide information regarding physical or chemical properties at the repair location. Some of the physical properties of the repaired piece of equipment, e.g., a fluid accommodating pipe, may be pressure or temperature of the fluid, in order to detect further leakage, if any.

In instances where the fluid in the pipe under pressure undesirably escapes due to inadequate repair, the FBG sensors in the patch would detect a pressure drop at the repair location. Similarly, any fluid leak would expose the fluid to the surrounding environment, and a temperature change would ensue at the repair patch. Installing FBG temperature sensors in the patch would enable instantaneous determination of any such change. Further, the FBG sensors may be sensitive to chemical content of the fluid and may provide not only quantitative, but also qualitative information as to what type of fluid is detected leaking through the patch. The FBG sensors may be able to detect various degrees of light diffraction, which is particularly useful with gas/liquid mixtures in order to ascertain whether the leakage through the repair consists primarily of gas, or of gas mixed with liquid. Moreover, the inserted FBG sensors may be capable of measuring conductivity/resistivity of the fluid in the pipe, thereby contrasting leaking water with oil or gas, for example. Any of the described FBG sensor types can be installed in combination with each other in order to complement each other's measurements and provide more complete diagnostics.

Moreover, the test may be within the scope of routine maintenance proscribed by, for example, a company's procedures and best practices or it may be mandated by governmental regulations. The test may be performed to measure changes in the environment of the object of interest, such as geological changes surrounding a buried pipeline, or the properties of the fluid inside the pipeline. In addition the health of the sleeve, the state of the anomaly under the sleeve may be monitored. The axial sensor may measure the bending or overburden of the pipe. This allows for cyclical fatigue measurements in offset, tee and elbow configurations. The hoop, on the other hand, may measure for changes in de-lamination of the sleeve, i.e., the health of the repair patch, and pressure or operational conditions of the pipeline. Changes in the wall thickness due to corrosion and leaks may be detected, as well.

The test results may be communicated to a remote system, such as a GPS system, where the properties of the buried pipeline may relate to the properties of the surrounding terrain. Such connectivity allows for the movement of the pipe to be correlated, and/or overlaid, to the local geographic changes in the surrounding terrain due to natural geological cycles or manmade overburdens resulting from growth of populations into areas not previously occupied. In addition, the test may provide a measurable baseline for the initial or desirable parameters, for future comparison in order to determine whether changes that affect the tested equipment are within or outside of permissible deviations from the baseline. These deviations over time, diurnal and seasonal over days, weeks, months and years, may be a function of the health of the sleeve and the anomaly under the sleeve. The FBG sensor measurements may further be performed on pipelines laid on land or, in the alternative, on subsea pipelines located on the seafloor, lakes, rivers and swamp lands.

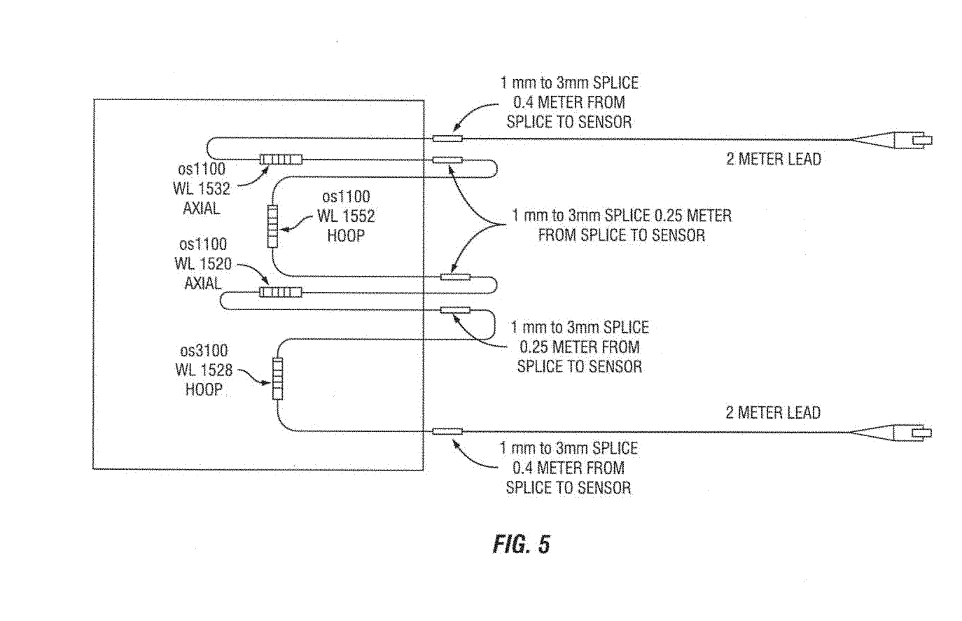

In the test shown in FIG. 5 two sensor types are used for evaluation. One type may be a bare FBG (e.g., os1100) and the other type an FBG mounted in a metal carrier (e.g., os3100), as shown in FIG. 5. The FBGs mounted in the metal carrier may be pre-stringed, which may improve their performance in high-pressure environments. Moreover, the metal carriers may be curved or otherwise shaped for optimal mounting and improved contact with an external surface of the evaluated equipment. In this example, two sets of sensors may be provided, one for the surface of the pipe under the clamp and one for the outside surface of the clamp. Each of the arrays may consist of four sensors in series, two bare FBGs and two carrier mounted FBGs. Each array may include two of the sensors mounted in the hoop (pressure) direction and two sensors mounted in the axial (bending) direction, also illustrated in FIG. 5. Accordingly, the hoop sensors may be sensitive to pressure internal to the pipe, i.e., pressure of the fluid in the pipe, or to variations of forces external to the pipe, for example, compressional forces. On the other hand, the axial sensors may be responsive to the external forces produced by, for example, geological changes in the surrounding environment. Moreover, some or all of the sensors may be sensitive to temperature changes, thereby providing additional information such as fluid leakage and the location of the leak. The number of sensor sets and the number of individual sensors in a set may be adjusted as deemed suitable. Some of the factors that influence decision making in terms of sensor selection and arrangement may be survivability of the sensors, their measurement accuracy under the specific circumstances, and the mounting constraints of the investigated equipment.

In the example presented in FIG. 5, several 1 mm-to-1 mm splices are included between any two connected sensors. The splices are located at 0.25 m from each of the sensors, but may be located at any distance from the sensors deemed appropriate. Further, this example also features two 1 mm-to-3 mm splices between the end sensors in the array and the corresponding two “home run” leads, one of the leads being provided for redundancy. The leads in this test are 2 m long and the splices between a home run and a sensor may be placed at 0.4 m from the sensor. Needless to say, these dimensions are not intended to be limiting and the lengths of the leads may be adjusted as necessary.

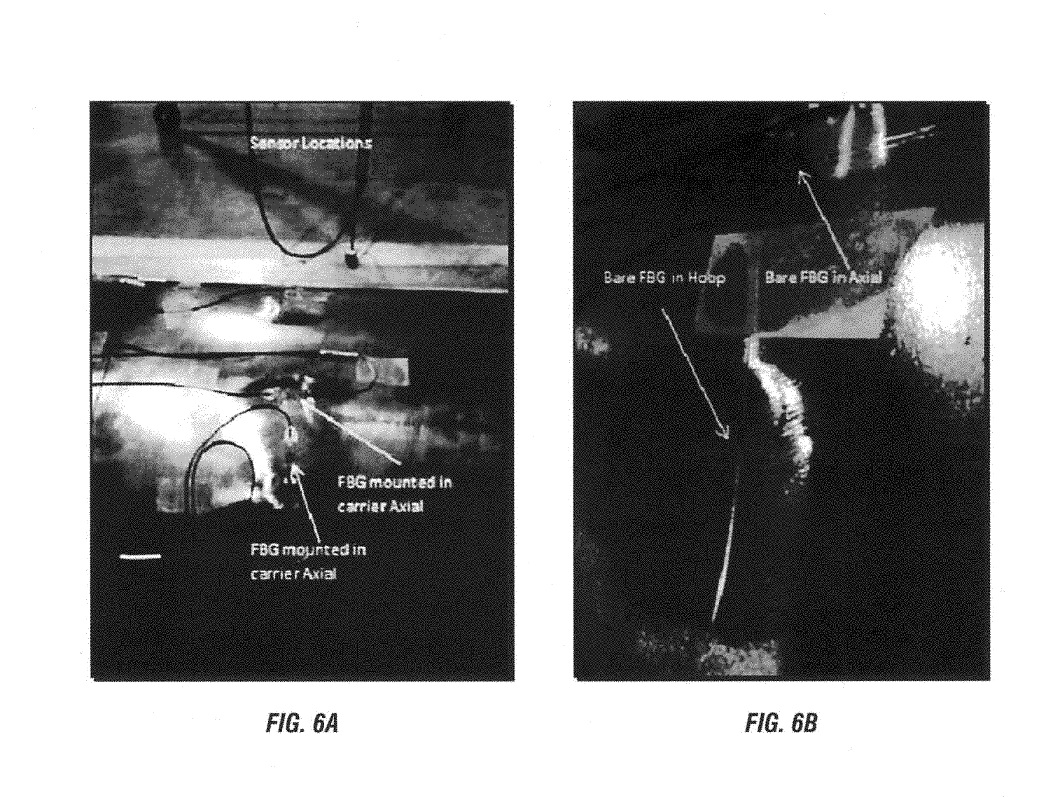

Note that using only one lead may be sufficient to interrogate a sensor array. The second lead may be added for redundancy in case of damage to the fiber during the clamp installation. The sensors may be unpacked and lined out on the pipe in preparation for installation. The bare FBGs may be attached to the pipe by using adhesive and the carrier mounted FBGs may be spot welded in position, as shown in FIGS. 6(a) and 6(b). The carrier mounted FBGs may be pre-stringed, prior to the detection.

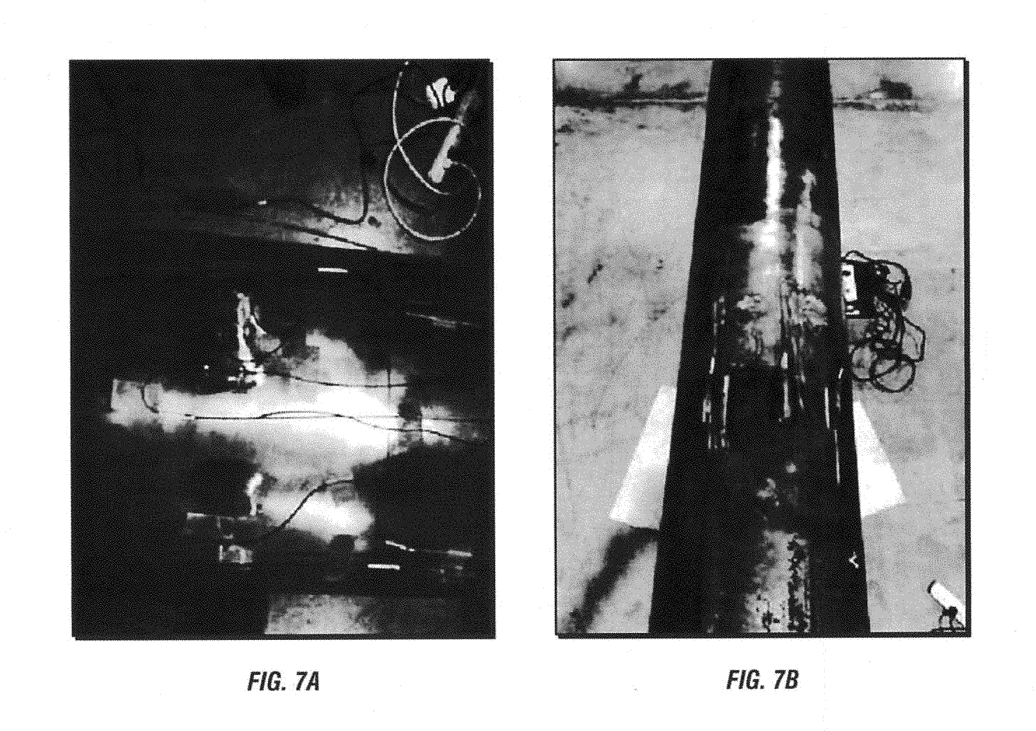

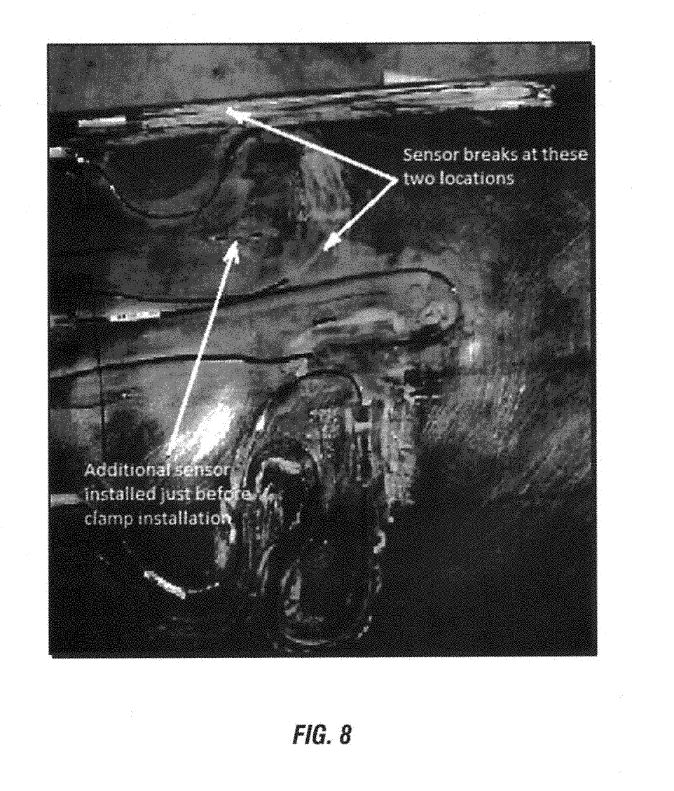

Next, as shown in FIGS. 7(a) and 7(b), epoxy may be applied over the sensors and sensor leads for reliable attachment and for protection during clamp installation. The sensors may be monitored the entire time during the installation process. A visual inspection of the sensor installation may be performed prior to the clamp installation. The epoxy coating on the sensors may be sanded to ensure molecular bond between the clamp and the epoxy. In the example illustrated in FIG. 8, during the sanding of the epoxy, the bare FBG is inadvertently sanded through just after a creating “home run” splice and again after the bare FBG is mounted in the hoop direction.

In the test, the two welded gages that are mounted in the metal carrier are recovered by connecting the redundant end of a sensor array into an interrogator. Moreover, an extra bare-FBG may be installed in the axial direction to ensure that two gage types, bare and carrier-housed, are maintained for the survivability test.

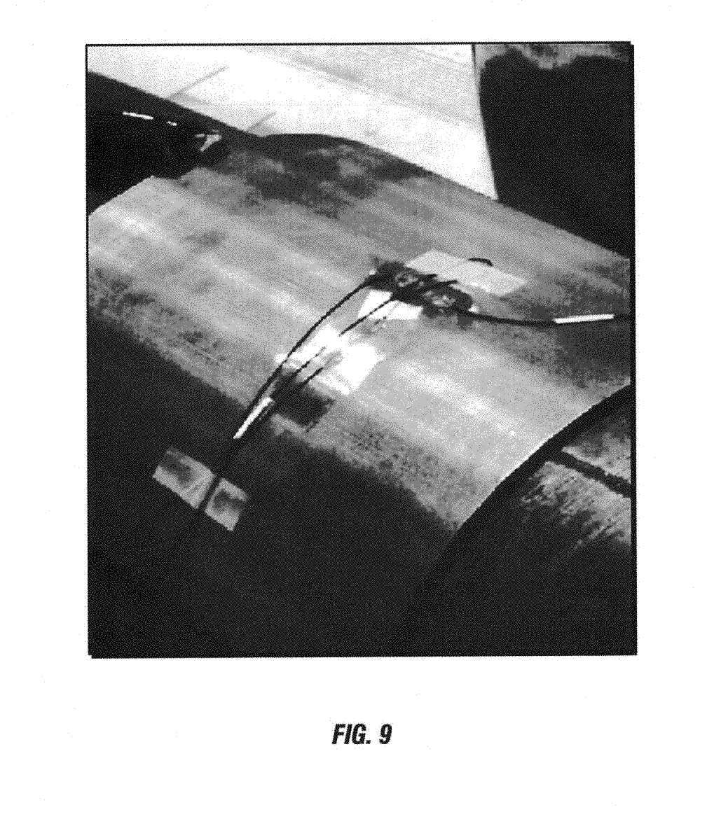

Further, the sensors may be mounted on a clamp before the clamp is installed and compressed. In one example, shown in FIG. 9, the sensor array for the surface of the clamp is adjusted by eliminating the two bare FBG sensors and by only installing the gages in metal carriers that are welded. The reason for this adjustment is that extra spacing of the clamping assemblies may be required for compressing and holding the clamp in place during a curing cycle. The clamp may be previously ground down and beveled at the edges so as not to sever the cables at the egress point from the clamp during the compression and torqueing of the clamp in position.

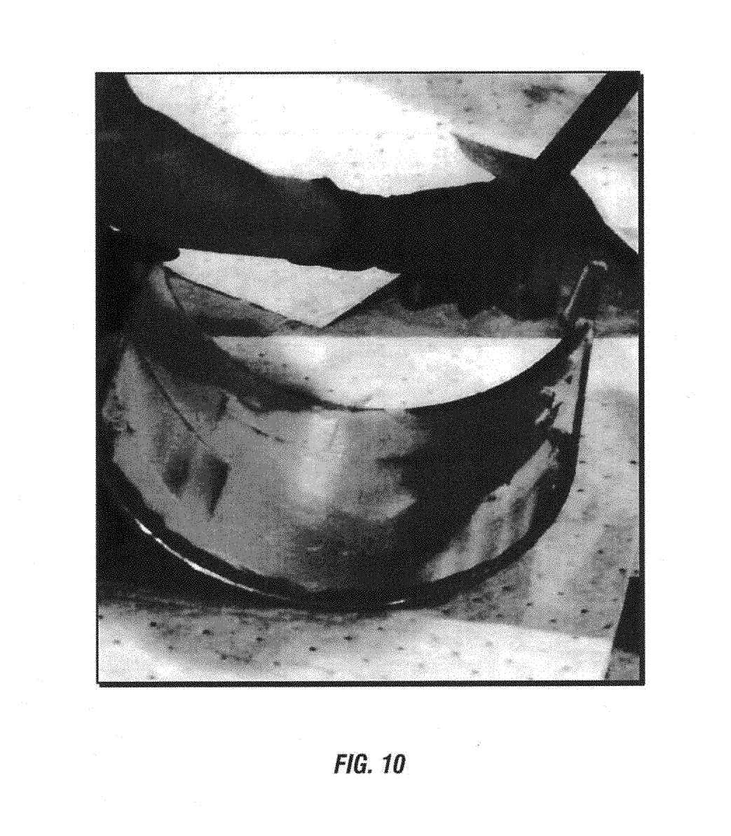

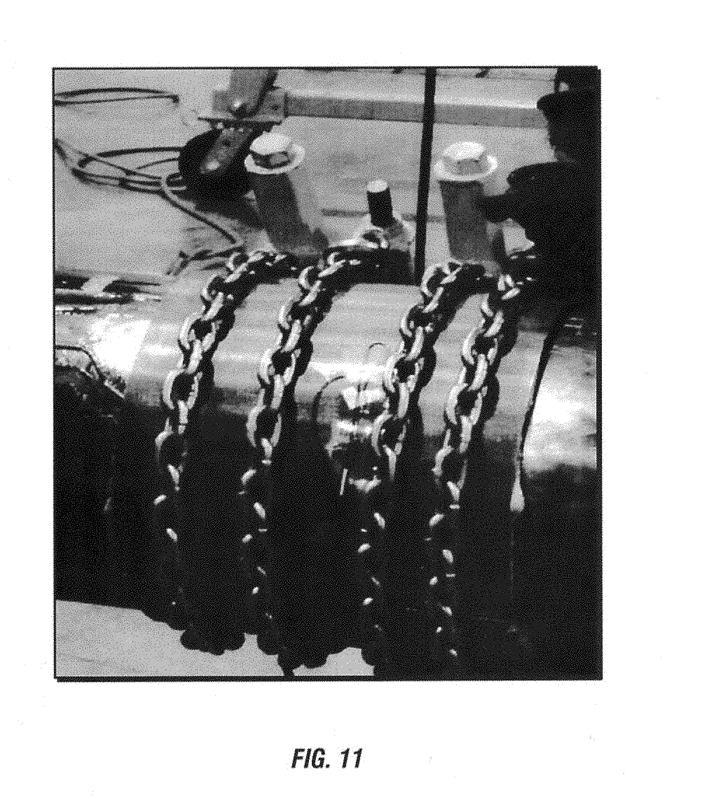

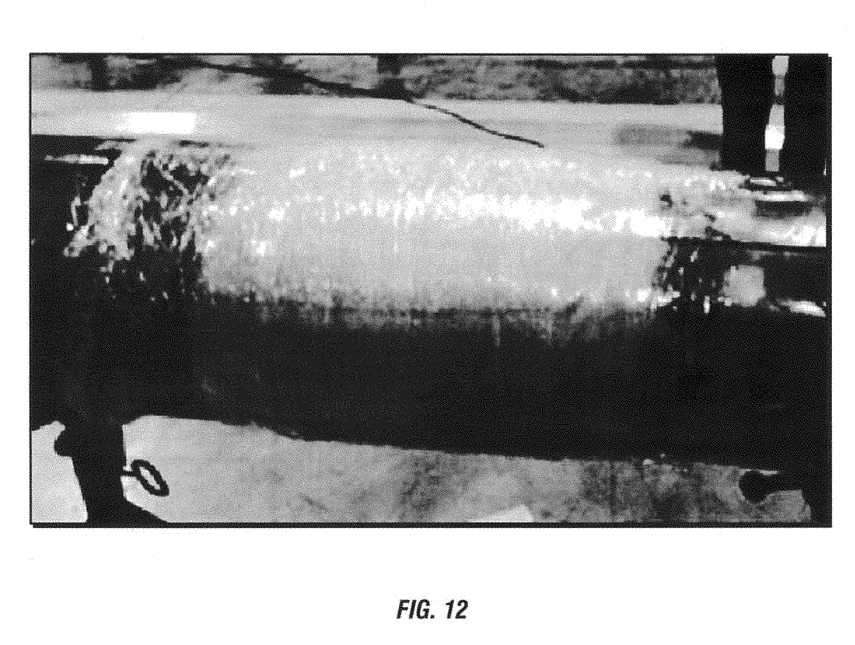

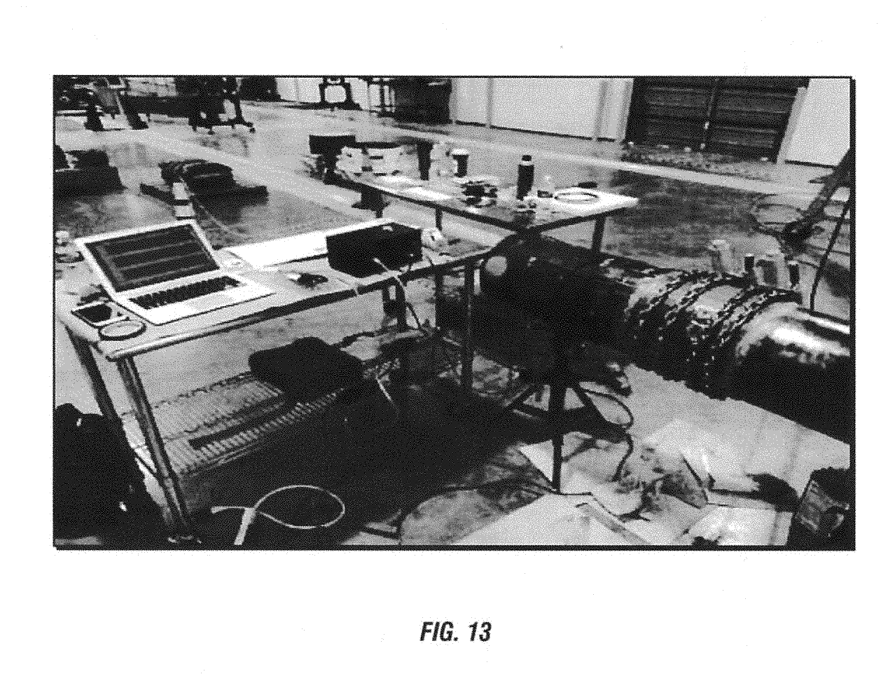

In the subsequent steps of the pipe test, a metal bonding adhesive may be applied to the inside surfaces of two clamp halves, one of them being depicted in FIG. 10, and placed on the pipe over the sensors mounted on the pipe surface. The two halves may be out of metal (e.g., steel), fiberglass, or carbon-fiber, or any other materiel deemed suitable. The clamps with chains may be wrapped around the pipe and torqued to 40 ft pounds with a torque wrench, as shown in FIG. 11. After the epoxy sets under the clamp, which may occur approximately 1½ hours later, the chains may be removed and the sensors on the clamp may be wrapped with E-Glass and epoxy wrap, as illustrated in FIG. 12. In the process of the clamp installation data may be logged during the torqueing and compression of the clamp and overnight during the curing cycle and subsequent stabilization period. Moreover, the sensors may be calibrated in accordance with the known external force applied on the clamp. FIG. 13 shows an example of an equipment setup for monitoring and recording the sensor response.

In another embodiment, a compartment may be machined for the FBGs to be integrated into the clamp, and then to be applied together onto the outer surface of the tested equipment.

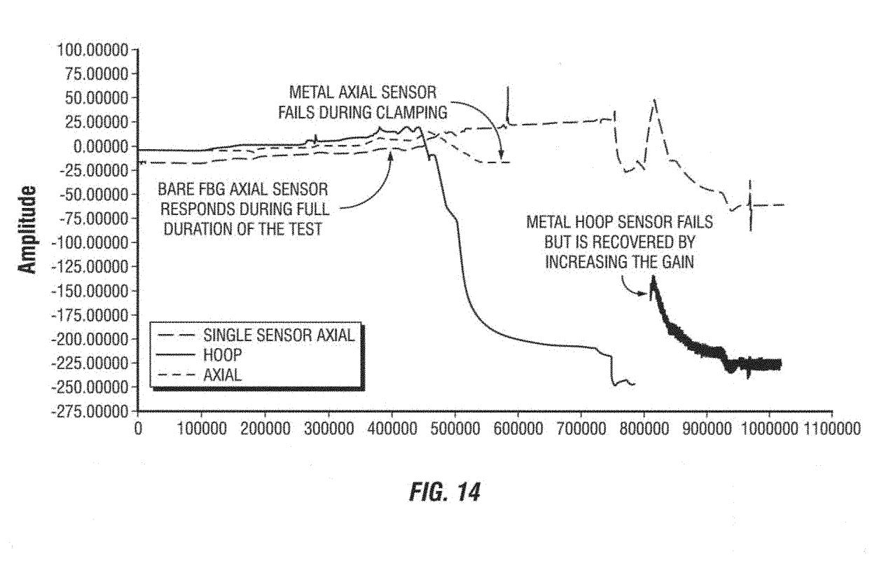

Turning to the measurement and data acquisition portion of the test, the wavelength recorded by FBGs may be converted to strain utilizing the formula of Equation 2 above. As compression is applied to the clamp, peaks of the two metal gages may be attenuated, eventually below the threshold for detection by the interrogator, as shown in the plot of FIG. 14. This dropout may later be compensated for by increasing the gain on the channel for the metal gages. In FIG. 14, the metal gage in the hoop direction is recovered by the gain increase. In the same way, as a result of adjusting the gain the bare FBG in the axial direction is functional. In the exemplary test, the metal gage in the axial direction is not recovered.

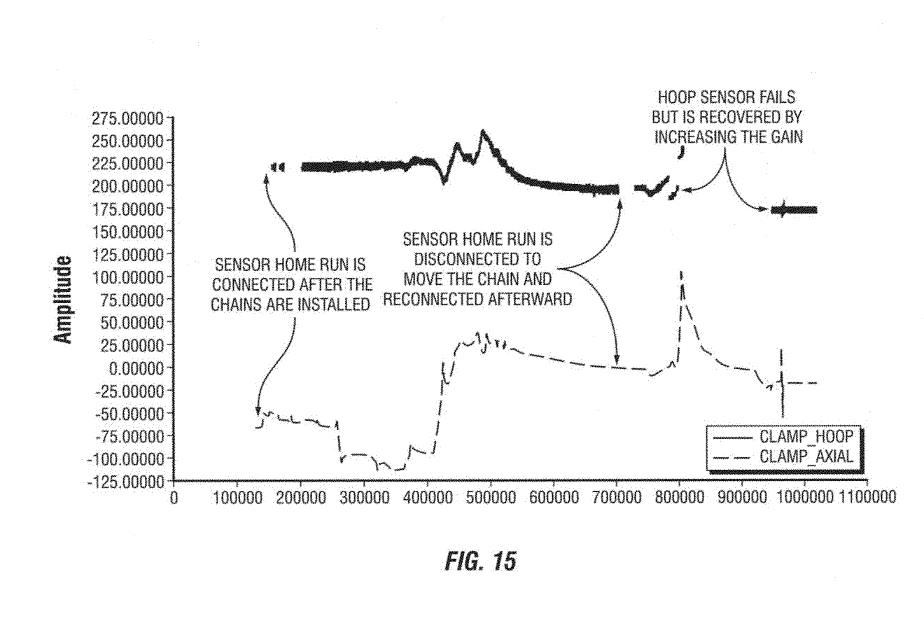

The plot of FIG. 15 reflects an example of the response of the sensors positioned on top of the clamp. In this log, during torqueing of the clamp the hoop sensor is attenuated but recovered by increasing the gain (top curve). Further, data recording in FIG. 15 is delayed during clamping to allow for the chains to be wrapped around the clamp. Additionally, data may be interrupted to move the chains and subsequently restarted.

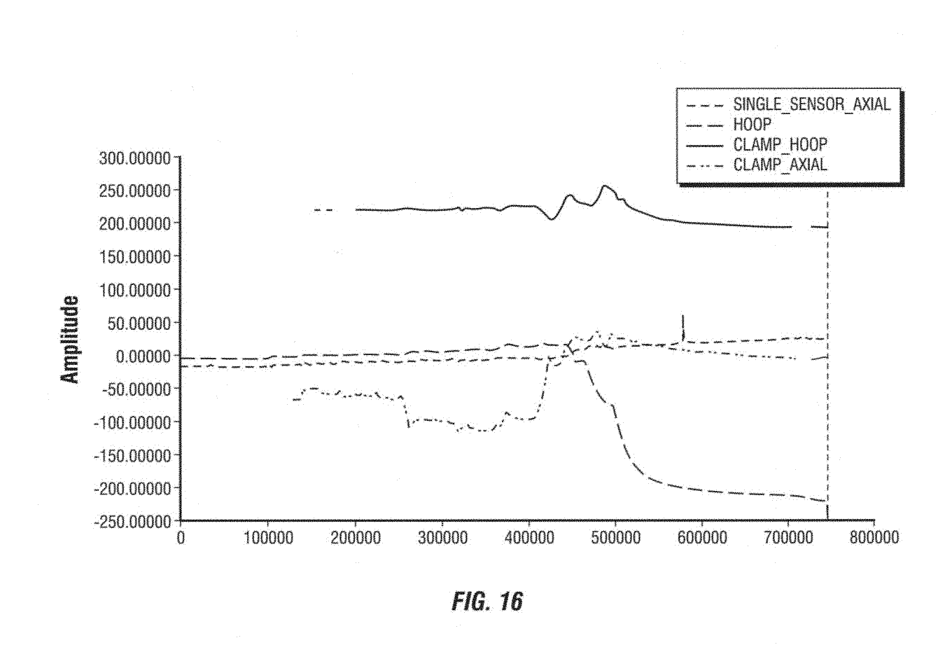

FIG. 16 shows a plot of sensors response during the torqueing of the clamp. The hoop sensor (top curve at T2) on the clamp responds sooner than the hoop sensor (bottom curve at T2) on the pipe. In this example, at T2 moment in time the hoop sensors are substantially equal and opposite in amplitude. The axial sensor (bottom middle curve at T2) on the clamp responds to the clamp bending until the chains are more evenly torqued and the amplitude approaches zero. The axial sensor (top middle curve at T2) on the pipe remains around zero throughout the torqueing, thereby indicating limited bending of the pipe during the torqueing.

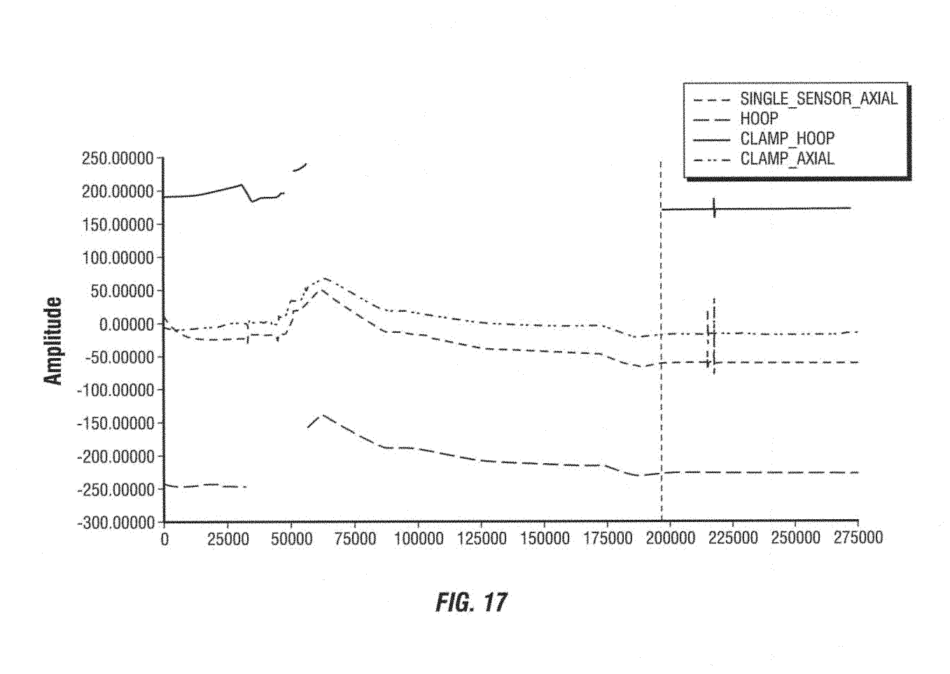

The plot of FIG. 17 shows a chronological continuity of the information illustrated in FIG. 16. T1 is a moment in time that corresponds to when the E-glass wrap is applied to the clamp and T2 marks the end of the curing cycle. All four curves are affected by the temperature increase during curing, soon after T1, and they subsequently settle down. The hoop (top line at T2) sensor on the surface of the clamp is lost during curing but is recovered later in time (e.g., the following day) by increasing the gain on the channel. In the scenario plotted in FIG. 17, the elapsed time between T1 and T2 is approximately 19 hrs. Subsequent to the T2 moment in time, the final residual strains in FIG. 17 are in their steady state indicating the pipe is in compression.

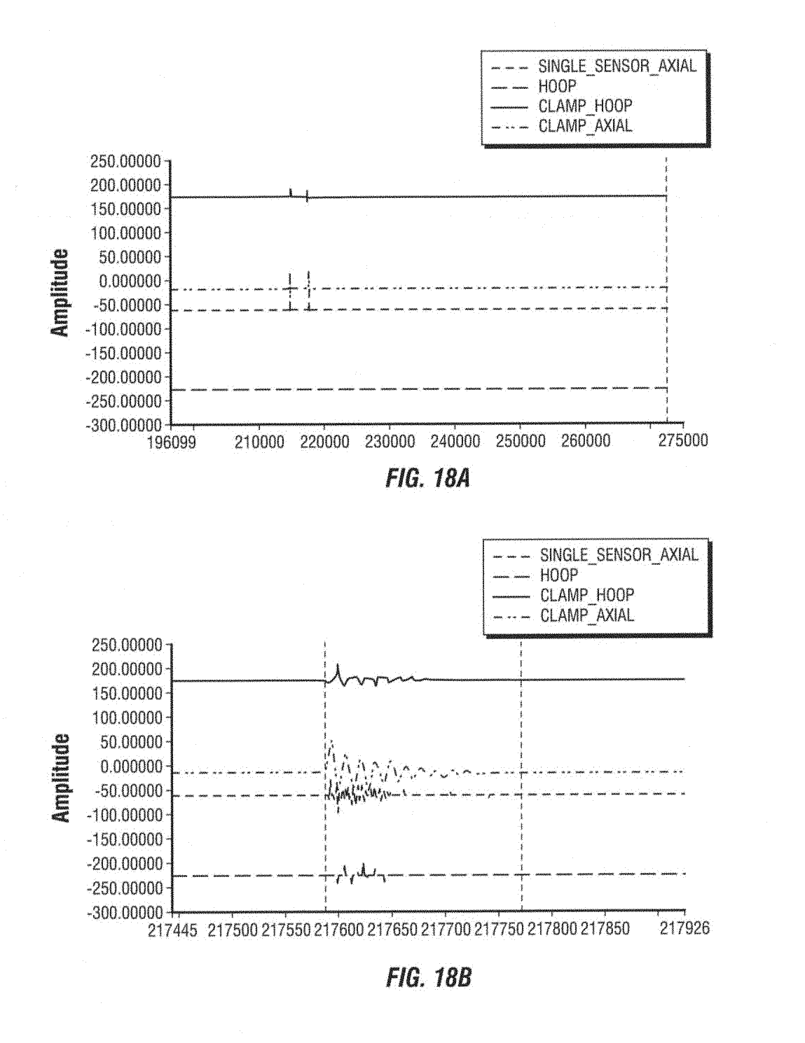

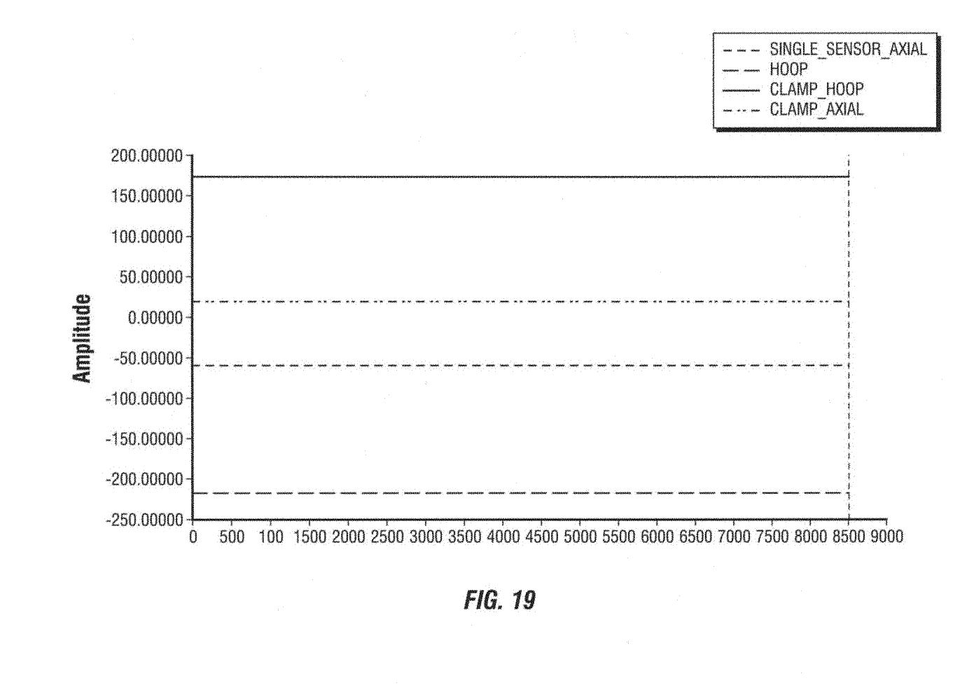

FIGS. 18(A) and (B) include graphs that show amplitudes of the sensors at steady state. In this example, two peaks are induced by tapping on the pipe to demonstrate the dynamic response of the monitoring system. The scale in the graph of FIG. 18(B) is expanded to focus on the ring down of the strike. The data acquired to be included in the plots in FIGS. 18(A) and (B) are acquired one day after the clamp installation. Approximately a week later, data may be acquired once again as presented in FIG. 19. The graph in FIG. 19 shows that the sensors are still at their steady state values indicating that integrity of the clamp has been maintained.

In the example of the present invention described above, some of the sensors are lost during the preparation of the pipe surface for clamp installation. This may occasionally occur if sanding is performed of the epoxy coating applied to the sensors for protection. During sanding, over the bare FBG sensors, the sand paper may pierce through the coating and damage the fiber. In such instances, a redundancy built into the sensor array may preserve the gages in the metal carriers and their measurements may be obtained by connecting them to a newly added lead. A spare sensor may be installed to maintain the continuity of the test. The bare fiber may exhibit low profile, and therefore show no attenuation and respond during the entire duration of the installation. The metal gages, due to their high profile, may attenuate significantly. Even when the metal axial gage is lost, the hoop sensor may survive and may be recovered by increasing the gain on it corresponding channel.

Although the present invention has been described in terms of specific embodiments, it need not necessarily be so limited. Suitable alterations/modifications for operation under specific conditions should be apparent to those skilled in the art, such as mounting an FBG equipped sleeve on a healthy portion of the pipe with no need for repair, in order to observe internal and/or external forces acting on the pipe. Moreover, in addition to evaluating a piece of equipment cylindrical in shape, as described above, the FBG supplied sleeve described above may be adjusted to fit any other cross-sectional shape. It is therefore intended that the following claims be interpreted as covering all such alterations/modifications as fall within the true spirit/scope of the invention.

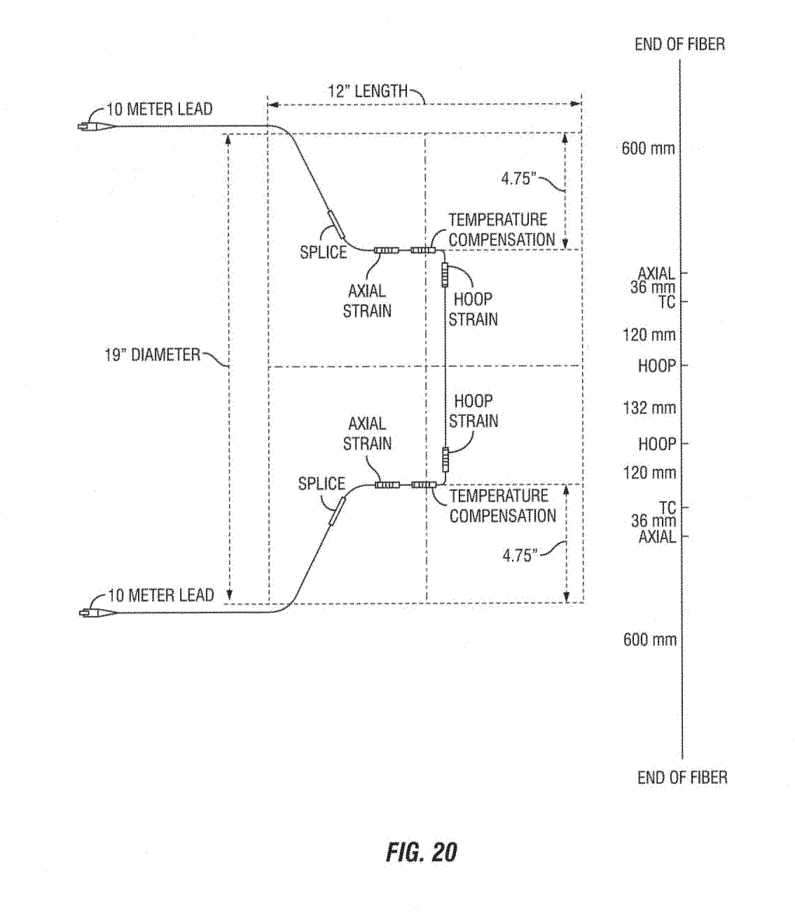

In one embodiment, shown in FIG. 20, a layout of the sensors in a flat plane is depicted in one half of a repair for a 12″ OD pipe. The configuration in FIG. 20 includes a total of four sensing “stations” comprised of three sensors for each station. In this example, each station has a temperature sensor and two strain sensors. One strain sensor may be oriented in the hoop direction for pressure measurements and the other in the axial direction for bending moments enabling tracking of cyclical fatigue. This orientation may be enabled for steel sleeve or the wet wrap composed of fiber glass or carbon fiber, for example.

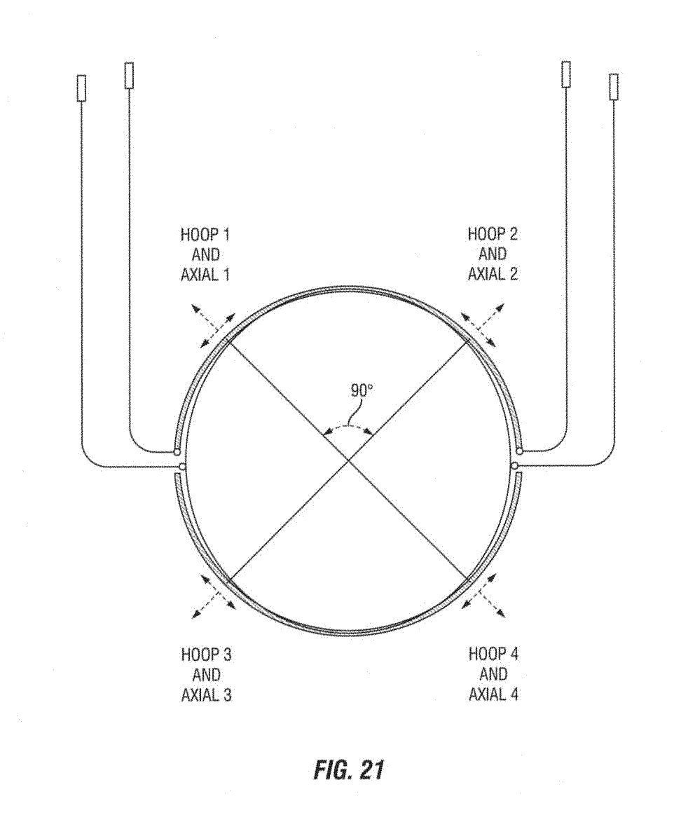

FIG. 21 represents an example repair in its final configuration. The sensor stations may be oriented to lie at 90° angles to one another. The four leads from each of the two sleeves may be included for four redundant paths for connection of sensors to equipment if the fiber is damaged or fails over time, or any redundancy related reason. Two leads may be coupled together and one lead may be connected to the equipment with the other as a backup.

What is claimed is:

1. A system for monitoring physical properties of industrial equipment, comprising:
a portion of industrial equipment;
at least one fiber-optic sensor that measures the physical properties of the portion of industrial equipment;
a sleeve placed over an external surface of the portion of industrial equipment; and
an attachment layer placed between the sleeve and the portion of industrial equipment that attaches the sleeve to the equipment;
wherein the at least one fiber-optic sensor is inserted in at least one of the following locations:
between the external surface of the portion of industrial equipment and an external surface of the sleeve, and
on the external surface of the sleeve.

2. The system of claim 1, wherein the at least one fiber-optic sensor is a Fiber Bragg Grating sensor.

3. The system of claim 1, wherein the portion of industrial equipment is a pipe.

4. The system of claim 3, wherein the sleeve is a patch placed on the pipe for repair.

5. The system of claim 4, wherein the at least one fiber-optic sensor provides diagnostics of a patched section of the pipe subsequent to the repair.

6. The system of claim 1, wherein the attachment layer is an adhesive material between the portion of industrial equipment and the sleeve.

7. The system of claim 6, wherein the at least one fiber-optic sensor is submerged in the adhesive material.

8. The system of claim 1, wherein the at least one fiber-optic sensor is integrated with the sleeve.

9. The system of claim 1, wherein the at least one fiber-optic sensor comprises:
an axial sensor that is substantially aligned with an axial axis of the monitored industrial equipment, and
a hoop sensor that is substantially perpendicular to the axial axis of the monitored industrial equipment.

10. The system of claim 1, wherein the at least one fiber-optic sensor comprises:
at least one set of sensors placed between the external surface of the portion of industrial equipment and the external surface of the sleeve, and
at least one set of sensors placed on the external surface of the sleeve.

11. A method for monitoring physical properties of industrial equipment, comprising:
preparing a portion of industrial equipment for sensor monitoring;
placing a sleeve and at least one fiber-optic sensor over the external surface of the portion of industrial equipment;
using an attachment layer to attach the sleeve to the portion of industrial equipment; and
measuring the physical properties of the portion of industrial equipment with the at least one fiber-optic sensor,
wherein the at least one fiber-optic sensor is inserted in at least one of the following locations:
between the external surface of the portion of industrial equipment and an external surface of the sleeve, and
on the external surface of the sleeve.

12. The method of claim 11, wherein the at least one fiber-optic sensor is a Fiber Bragg Grating sensor.

13. The method of claim 11, wherein the portion of industrial equipment is a pipe.

14. The method of claim 13, wherein the sleeve is a patch placed on the pipe for repair.

15. The method of claim 14, further comprising:
using the at least one fiber-optic sensor to provide diagnostics of a patched section of the pipe subsequent to the repair.

16. The method of claim 11, wherein the attachment layer is an adhesive material between the portion of industrial equipment and the sleeve.

17. The method of claim 16, further comprising:
submerging the at least one fiber-optic sensor in the adhesive material.

18. The method of claim 11, further comprising
integrating the at least one fiber-optic sensor with the sleeve.

19. The method of claim 11, wherein the at least one fiber-optic sensor comprises:
an axial sensor that is substantially aligned with an axial axis of the monitored industrial equipment, and
a hoop sensor that is substantially perpendicular to the axial axis of the monitored industrial equipment.

20. The method of claim 11, wherein the at least one fiber-optic sensor comprises:
at least one set of sensors placed between the external surface of the portion of industrial equipment and the external surface of the sleeve, and
at least one set of sensors placed on the external surface of the sleeve.
